(19) United States
(12) Patent Application Publication
(10) Pub. No.: US 2009/0319459 A1
(43) Pub. Date: Dec. 24, 2009

(54) Physically-animated Visual Display

(75) Inventors: Cynthia Lynn Breazeal, Cambridge, MA (US); Rosalind Wright Picard, Newton, MA (US); Hyungil Ahn, Cambridge, MA (US); Guy Hoffman, Somerville, MA (US)

Correspondence Address: NORMA E HENDERSON;HENDERSON PATENT LAW, 13 JEFFERSON DR, LONDONDERRY, NH, 03053, US

(73) Assignee: Massachusetts Institute of Technology, Cambridge, MA (US)

(21) Appl. No.: 12/390,405

(22) Filed: Feb. 20, 2009

Related U.S. Application Data
(60) Provisional application No. 61/030,223, filed on Feb. 20, 2008.

(51) Int. Cl. G06N 5/02; H04N 7/18

(52) U.S. Cl. 706/46; 348/77; 348/E07.085; 901/1; 901/46

(57) ABSTRACT

A physically animated visual display is a robotic device, capable of multiple degree-of-freedom motion, that is adapted to improve a user's emotional state, cognitive performance, and comfort level through reactive and goal-directed manipulation of the position of the display. The affective-cognitive system comprises a feature extraction subsystem for deriving physical information about a user from data obtained from sensors, a perception subsystem for processing the data in order to determine the user's current emotional state, affective-cognitive state, or posture, an action selection subsystem for determining an action to be taken in response, and a motor system for physically animating the robotic device in accordance with the determined action. The system may include feedback modeling based on a reaction of the user to the movement of the apparatus increasing or decreasing the probability of choosing the current behavior based on the user's reaction.

### RELATED APPLICATIONS

This application claims the benefit of U.S. Provisional Application Ser. No. 61/030,223, filed Feb. 20, 2008, the entire disclosure of which is herein incorporated by reference.

### STATEMENT REGARDING FEDERALLY SPONSORED RESEARCH OR DEVELOPMENT

This invention was made with U.S. government support under Grant Number IIS-0533703, awarded by the National Science Foundation. The government has certain rights in this invention.

### FIELD OF THE TECHNOLOGY

The present invention relates to robotic devices and, in particular, to a physically animated visual display that moves in response to a user.

### BACKGROUND

It is well recognized that how a person feels can influence what they think and do, usually because of personal observation of how extreme emotions inspire negative thoughts, actions, and more. However, there is also a growing body of findings from psychology, cognitive science, and neuroscience in which more subtle affective states have been shown to systematically influence cognition [A. M. Isen, “Positive affect and decision making”, In M. Lewis and J. Haviland, editors, Handbook of Emotions, Guilford, N.Y., 2nd edition, 2000; J. Lerner et al., “Heart strings and purse strings: Carryover effects of emotions on economic decisions”, Psychological Science, 15(5):337-341, May 2004; C. Nass, I.-M. Jonsson, H. Harris, B. Reeves, J. Endo, S. Brave, and L. Takayama, “Improving automotive safety by pairing driver emotion and car voice emotion,” CHI 2004 Proceedings, Portland, Oreg., 2004; N. Schwartz, “Situated cognition and the wisdom in feelings: Cognitive tuning”, In L. F. Barrett and P. Salovey, editors, The Wisdom in Feeling, pages 144-166, The Guilford Press, 2002]. In particular, a number of studies have explored the effect of body posture on affect and cognition [J. Riskind, “They stoop to conquer: Guiding and self-regulatory functions of physical posture after success and failure”, Journal of Personality and Social Psychology, 47:479-493, 1984; J. Riskind and C. Gotay, “Physical posture: Could it have regulatory or feedback effects upon motivation and emotion?”, Motivation and Emotion, 6:273-296, 1982; S. Duclos, J. Laird, E. Schneider, M. Sexter, L. Stern, and O. Van Lighten, “Emotion-specific effects of facial expressions and postures on emotional experience”, Journal of Personality and Social Psychology, 57:100-108, 1989; V. Wilson and E. Peper, “The effects of upright and slumped postures on recall of positive and negative thoughts”, Applied Psychophysiology and Biofeedback, 29:189-195, 2004]. An example is the theory postulated in Riskind's “stoop to conquer” research, where it was found that incongruous postures, such as slumping after a success, negatively affected subsequent performance, while congruous postures, such as slumping after a failure, helped to mitigate the effects of failing.

These studies indicate that affect and emotional experience interact with cognition in significant and useful ways. Current understanding is that emotion plays a useful role in regulating learning, creative problem solving, and decision making. For example, Isen shows that a positive mood promotes a tendency toward greater creativity and flexibility in negotiation and in problem solving, as well as more efficiency and thoroughness in decision making [A. M. Isen, “Positive affect and decision making”, In M. Lewis and J. Haviland, editors, Handbook of Emotions, Guilford, N.Y., 2nd edition, 2000]. These effects have been found across many different groups, ages, and positive affect manipulations. Other specific influences of affect on cognition have also been found for negative affective states, e.g., Schwartz argues that being in a sad mood enables better performance on certain kinds of analytic tests [N. Schwartz, “Situated cognition and the wisdom in feelings: Cognitive tuning”, In L. F. Barrett and P. Salovey, editors, The Wisdom in Feeling, pages 144-166, The Guilford Press, 2002].

The effects can be significant even for rational decisions that people don't think of as being influenced by emotion. For example, Lerner et al. [J. Lerner et al., “Heart strings and purse strings: Carryover effects of emotions on economic decisions”, Psychological Science, 15(5):337-341, May 2004] have shown that two different kinds of negative feelings, disgust and sadness, had significantly different effects on the prices people would accept to get rid of an item, or pay to acquire an item. These emotions changed people's economic decision-making behavior, and in the case of disgust even reversed the classic endowment effect whereby people want to sell things for more than they want to buy them for. Meanwhile, people in a neutral mood exhibited the classic endowment effect, suggesting that previous studies either averaged across moods or reflected subjects with neutral moods.

Emotion not only influences cognition, but it also interacts with information in the environment in ways that can enhance or hinder your ability to perform. Cliff Nass and colleagues, while trying to decide if a voice in the automobile driver's environment should sound subdued and calm or energetic and upbeat, ran an experiment trying both kinds of voices [J. Lerner et al., “Heart strings and purse strings: Carryover effects of emotions on economic decisions”, Psychological Science, 15(5):337-341, May 2004]. They also looked at the two conditions where drivers were either upset or happy. In a total of four conditions, the happy or upset drivers drove in a simulator with either an energetic voice or a subdued voice talking to them and asking them questions. On multiple measures of driving performance and cognitive performance, happy drivers did better overall than upset drivers. In addition, when the voice was congruous with the driver's state (energetic/upbeat for happy drivers, subdued/calm for upset drivers), then performance was significantly better than in the two incongruous conditions. The worst performance of all four conditions occurred when the upset drivers were paired with the energetic and upbeat voice. This study demonstrates that performance can be improved by mood congruent interaction.

Conveyance of interpersonal attitude is one of the most important uses of nonverbal behavior in relationship building and maintenance [Argyle, M., Bodily Communication, New York, Methuen & Co. Ltd, 1988]. The display of positive or negative attitude can greatly influence initial perceptions of people we meet and whether we approach them or not. The most consistent finding in this area is that the use of nonverbal “immediacy behaviors” (also called affiliative or liking behaviors)—close conversational distance, direct body and facial orientation, forward lean, increased and direct gaze, smiling, pleasant facial expressions and facial animation in general, nodding, frequent gesturing and postural openness—projects liking for the other and engagement in the interaction, and is correlated with increased solidarity [Argyle, 1988, Richmond, V., and McCroskey, J., “Immediacy, Nonverbal Behavior in Interpersonal Relations”, Boston, Allyn & Bacon, 1995 pp. 195-217]. Immediacy behaviors alone, displayed by a teacher, have been shown to increase learning outcomes [Christensen, L., and Menzel, K., “The linear relationship between student reports of teacher immediacy behaviors and perception of state motivation, and of cognitive, affective, and behavioral learning”, Communication Education, 47; 82-90, 1998].

In human-computer interfaces, immediacy behaviors were implemented and evaluated in a virtual exercise advisor and were shown, in conjunction with several other relational behaviors, to result in significantly increased liking of the agent, desire to continue working with the agent, trust in the agent, and belief that the agent genuinely cared about the user [Bickmore, T., “Relational Agents: Effecting Change through Human-Computer Relationships,” MIT Ph.D. Thesis, Cambridge, Mass., 2003]. Most of these measures were part of a standard instrument from clinical psychotherapy—the Working Alliance Inventory—that measures the trust and belief that the therapist and patient have in each other as team-members in achieving a desired outcome [Horvath, A., & Greenberg, L., “Development and Validation of the Working Alliance Inventory”, Journal of Counseling Psychology, 36(2), 223-233, 1989].

A number of tools have been developed for building agents that would respond to the learner's affective state. This includes defining, designing, and testing “relational agents,” agents capable of building long-term social-emotional relationships with people. Most agents in existence are at best charming for a short interaction, but rapidly grow tiring or annoying with longer term use. In order to build an agent that people will enjoy interacting with over time, it must be able to both accumulate memory of ongoing interactions with the user, and also exhibit several basic social-emotional skills, so it can respond in ways that appears to be intelligent, given one's affective state and expressions.

A series of Human Robot Interaction (HRI) studies explored how the medium through which an interaction takes place affects a person's perception of social presence of a character [Kidd, C. & Breazeal, C., “Comparison of Social Presence in Robots and Animated Characters”, International Journal of Human Computer Studies, Special Issue on Human Robot Interaction, 1993]. In these studies, the robot had static facial features with movable eyes mounted upon a neck mechanism. The study involved naive subjects (n=32) interacting with a physical robot, an on-screen animated character, and a person in a simple task. Each subject interacted with each of the characters, one at a time, in a pre-assigned order of presentation. The character made requests of the subject to move simple physical objects (three colored blocks). All requests were presented in a pre-recorded female voice to minimize the effects of different voices, and each character made these requests in a different order. At the conclusion of the interaction, the subject was asked to complete a questionnaire on their experiences based on the Lombard & Ditton scale for measuring social presence [Lombard, M., Ditton, T. B., Crane, D., Davis, B., Gil-Egul, G., Horvath, K. and Rossman, J., “Measuring Presence: A Literature-Based Approach to the Development of a Standardized Paper-and-Pencil Instrument”, Presence 2000: The Third International Workshop on Presence, Delft, The Netherlands, 2000]. Subjects were asked to read and evaluate a series of statements and questions about engagement with the character on a seven-point scale. All data were evaluated using a single-factor ANOVA and paired two-sample t-tests for comparisons between the robot and animated character. The data presented were found to be statistically significant to p<0.05. The robot consistently scored higher on measures of social presence than the animated character (and both below that of the human). Overall, people found the robot character to be easier to read, more engaging of their senses and emotions, and more interested in them than the animated character. Subjects also rated the robot as more convincing, compelling, and entertaining than the animated character. These findings suggest that in situations where a high level of motivational and attentional arousal is desired, a physically co-present and animated computer may be a preferred medium for the task over an animated character “trapped” within a screen.

### SUMMARY

A physically animated visual display is adapted to improve a user's emotional state, cognitive performance, and perception of the user's comfort level through reactive and/or goal-directed manipulation of the position of the display. The display provides a robotic platform that relates to the user in order to improve task performance measures and ergonomic factors. In a preferred embodiment, a “head” has an LCD screen and is mounted on a mechanical neck at a joint that provides three degrees of freedom. The neck is mounted at its other end on a base at a joint that provides a further two degrees of freedom.

In a preferred embodiment of the cognitive-affective scheme, a perception system processes data received from a feature extraction subsystem in order to determine the user's cognitive-affective state. The feature extraction subsystem derives this data from data obtained by various sensors and other perception systems. A memory system provides the user's cognitive-affective state to an action selection system, which determines a responsive action to be taken by the device. This action is then implemented via a motor system, using motors, the graphical display, and/or audio outputs.

In one aspect, the invention is a physically-animated apparatus for improving a user's current attention, cognitive performance, or emotional state, comprising a robotic device capable of multiple degree-of-freedom motion and an affective-cognitive system. The affective-cognitive system preferably comprises a feature extraction subsystem, adapted for deriving physical information about a user from data obtained from at least one device configured for sensing current physical state data about the user, a perception subsystem, adapted for processing the physical information received from the feature extraction subsystem in order to determine the user's current emotional or affective-cognitive state, an action selection subsystem, adapted for determining an action to be taken in response to the determined emotional or affective-cognitive state, and a motor system, the motor system comprising at least one device adapted to physically animate the robotic device in accordance with the determined action. The action selection subsystem may include feedback modeling based on a reaction of the user to the movement of the apparatus.

In another aspect, the invention is a physically-animated apparatus for improving a user's physical comfort level, comprising a robotic device capable of multiple degree-of-freedom motion and an affective-cognitive system. The affective-cognitive system preferably comprises a feature extraction subsystem, adapted for deriving physical information about a user from data obtained from at least one device configured for sensing current physical state data about the user, a perception subsystem, adapted for processing the physical information received from the feature extraction subsystem in order to determine the user's current posture, an action selection subsystem, adapted for determining an action to be taken in response to the determined posture and a set of user postural and movement goals, and a motor system, the motor system comprising at least one device adapted to physically animate the robotic device in accordance with the determined action. The action selection subsystem may include feedback modeling based on a reaction of the user to the movement of the apparatus.

In yet another aspect, the invention is a method for improving a user's attention, emotional state, cognitive-affective state, or posture, comprising the steps of detecting the user's identity, monitoring the user's current affective state, if the user is in a non-neutral affective state, determining whether the user is bored, distracted, blinking, or taking a break, if not, displaying attention-following behavior, determining the user's emotional state, displaying empathetic behavior based on the determined emotional state, determining the user's feelings about the current behavior, and increasing or decreasing the probability of choosing the current behavior based on the determined feelings.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a block diagram depicting an overview of an embodiment of the cognitive-affective architecture of a physically animated visual display, according to one aspect of the invention;

FIG. 2 is a conceptualized drawing of the “RoCo” prototype;

FIGS. 3A and 3B depict the implemented “RoCo” prototype;

FIGS. 4A-C depict an embodiment of a physically animated display in different exemplary postures, according to one aspect of the invention;

FIG. 5 depicts wiring details for the “RoCo” prototype implementation;

FIGS. 6A and 6B are diagrams of the PCI control card of the “RoCo” prototype implementation;

FIG. 7 is a block diagram illustrating the functionality of an embodiment of the cognitive-affective architecture of a system according to one aspect of the present invention;

FIG. 8 is a block diagram illustrating an embodiment of the process of recognizing the user's state, according to one aspect of the invention;

FIGS. 9A and 9B depict a flowchart outlining an embodiment of a methodology for improving a user's postural movement and overall posture, according to one aspect of the invention;

FIG. 10 is a flowchart outlining an embodiment of a methodology for improving a user's mood state through empathic mirroring behavior, according to one aspect of the invention;

FIG. 11 is a flowchart outlining an embodiment of a methodology for improving a user's cognitive performance, according to one aspect of the invention;

FIGS. 12A and 12B depict a flowchart outlining an embodiment of a methodology for both improving a user's cognitive performance and building social rapport through the affect-congruent posing of the system, according to one aspect of the invention;

FIGS. 13A and 13B depict a flowchart outlining an embodiment of a methodology for improving a user's attention state, according to one aspect of the invention; and

FIG. 14 is a flowchart outlining an embodiment of a methodology for attracting and improving a guest's attention state, according to one aspect of the invention.

### DETAILED DESCRIPTION

A physically animated visual display is adapted to improve a user's emotional state, cognitive performance, and perception of the user's comfort level through reactive and/or goal-directed manipulation of the position of the display. The display provides a robotic platform designed to relate to its user in order to improve task performance measures and ergonomic factors. The physically animated display moves in subtly expressive ways that respond to and promote its user's postural movement. The physical embodiment and animated movement of a machine in relation to its user's body and affective states can bring cognitive and health-related benefits. The prototype embodiment, known as “RoCo”, is a robotic computer that moves its monitor with an articulated “neck” and “head”. RoCo behaves in subtly expressive ways that respond to its user's postural shifts, affective and cognitive states, and promote postural movement without distracting or annoying the user.

Motivated by Riskind's “Stoop to conquer” research, where it was found that postures congruous to the type of outcome a person received (e.g. slumping following a failure or sitting up proudly following a success) led to significantly better performance in a subsequent cognitive task than incongruous postures (e.g. sitting up proudly following a failure or slumping following success), two experiments were performed where the “RoCo” prototype was used to manipulate its user's posture. The results show that people tended to be more persistent on a subsequent task and feel more comfortable when the devices posture was congruous to their affective state than when it was incongruous.

One potential benefit of introducing increased postural movement into computer use is reduced back pain, where physical movement is recognized as one of the key preventative measures. The device's physical interactions with its user's affective and cognitive states are intentionally designed to improve the efficacy of computer use. The system is designed to increase user movement and improve user experience when the user approaches, sits near, or works at a desktop computer. The articulated monitor moves in a smooth, quiet, expressive way, has various behaviors ranging from unnoticeable and non-distracting to sociable and attention-getting. Thus, it might, for example but not limited to, “dance” to attract a new user, bow to greet him or her, and then hold perfectly still while the user is working, moving only in nondistracting ways at task boundaries and when the user shifts attention. The device can be customized to increase a person's physical movement (e.g. to improve posture) and/or to improve experience (e.g. to obey certain social rapport conventions). The device can identify the appropriate movements to use by sensing and responding to the physical, cognitive, and affective state of the user through various customizable sensor inputs as well as by reasoning about and learning the personal preferences of each user.

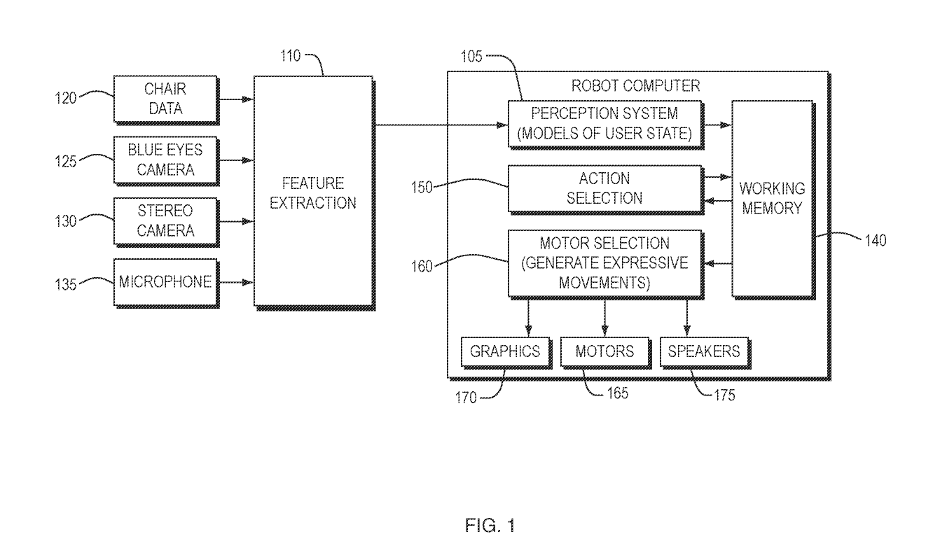

The major components of the system provide the expressive physically animated display, perceptual systems for passively sensing subtle movement and expression by the user, and a cognitive-affective control system. FIG. 1 is a block diagram depicting an overview of the cognitive-affective scheme of an embodiment of the system. In FIG. 1, Perception System 105 processes data received from feature extraction subsystem 110 in order to determine the user's cognitive-affective state. Feature extraction subsystem 110 derives this data from data obtained by various sensors and other perception systems, such as, but not limited to, those shown, which include chair sensors 120, blue eyes camera 125, stereo camera 130, and microphone 135. Memory System 140 provides the user's cognitive-affective state to Action Selection System 150, which determines a responsive action to be taken by the device. This action is then implemented via Motor System 160 via motors 165, graphics 170, and audio outputs 175.

A preferred embodiment, as implemented in the prototype “RoCo” robot, comprises four sub-components: the physical robot itself, the behavior engine, the motor control system, and the sensory input system. The physical robot has five degrees of freedom that manipulate a mechanical neck with a LCD screen, its head, mounted on it. Three degrees of freedom control display (head) motion: head yaw, head pitch, and head roll. Two additional degrees of freedom control the neck: base yaw and base pitch. These five degrees permit the “RoCo” prototype to perform a wide variety of simple motions, including nodding, shaking its head, and leaning forward. These life-like motions are sufficient to implement a wide variety of immediacy social behaviors and to inspire natural postural changes in the user. It is interfaced to a MEI motion controller to drive the motors. The robot has no explicit facial features.

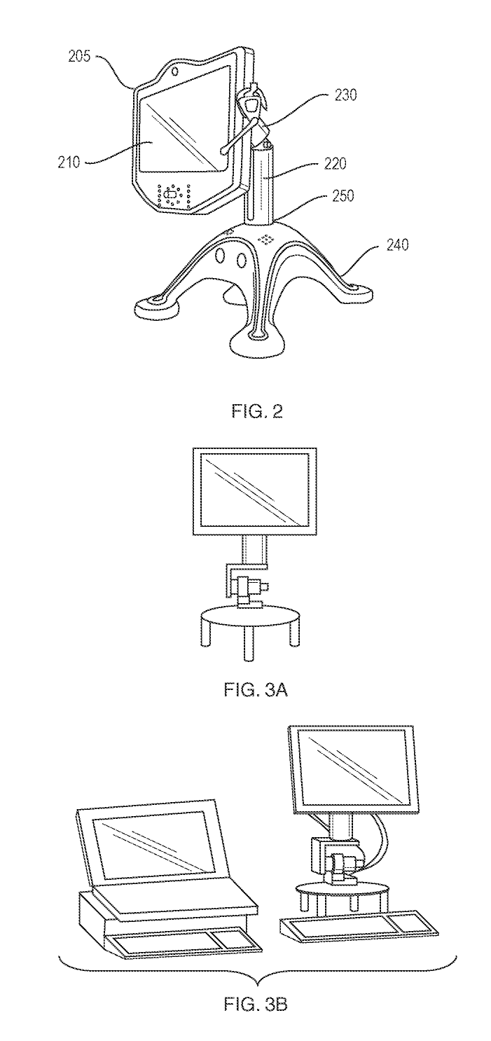

FIG. 2 is a conceptualized drawing of the “RoCo” prototype. In FIG. 2, head 205 has LCD screen 210 and is mounted on mechanical neck 220 via head joint 230, which has three degrees of freedom. Mechanical neck 220 is mounted on base 240 via base joint 250, which provides a further two degrees of freedom. FIGS. 3A and 3B are photographs of the physically-implemented prototype.

It will be clear to one of skill in that that, although the prototype implementation described herein is a robotic computer, the system of the present invention may be advantageously implemented with any type of device having a visual display. Such devices include, but are not limited to, computer monitors, laptop displays, television screens, DVD players, video game displays, monitoring equipment screens, and any other type of device that requires or encourages users to spend time looking at a visual display.

Character animators have long appreciated the importance of body posture and movement (i.e., the principle axes of movement) to convincingly portray life and to convey expression in inanimate objects [Thomas, F. & Johnson, O., “The Illusion of Life: Disney Animation”, Hyperion, New York, 1981]. Special attention was therefore paid to RoCo's design for producing smooth backlash-free movement, quiet operation, and the ability to move with velocities and accelerations necessary to convey expressive states and animations. RoCo's five degrees are sufficient to perform a wide variety of expressive and communicative motions. High-level motion trajectories are generated by the C5M behavior engine developed at the MIT Media Lab to control interactive characters (both animated and robotic). This codebase can generate real-time expressive behavior either from hand-crafted source animations, or using procedural techniques.

The primary use of the LCDs in the prototype is to display task relevant information. However, it will be clear to one of skill in the art that it can also be advantageously used to display facial animations, other sorts of graphical information, videos, or any other content capable of presentation on a visual display. The system may also be equipped with other features, such as, but not limited to, camera input, microphone input, and speaker output. The system can also express itself through non-linguistic auditory channels, although this does not preclude the use of speech synthesis if the task demands it.

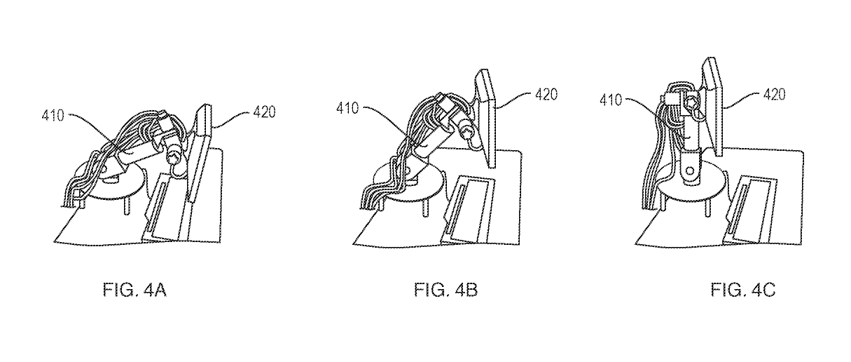

The physically animated display can freely move its monitor “head” and its mechanical “neck”, as shown in the three exemplary postures depicted in FIGS. 4A-C. In FIG. 4A, neck 410 is leaning fully forward, and head 420 is tilted forward. In FIG. 4B, neck 420 is partially leaning, and head 420 is upright. In FIG. 4C, both neck 410 and head 420 are fully upright. There are two axes of rotation at the “head”, an “elbow” joint, and a “swivel” and a “lean” degree of freedom at the base. It does not have explicit facial features, but this does not preclude the ability to display these graphically on the LCD screen. The display communicates its expression using the 5-degree of freedom mechanical “neck” and “head”. For instance, the mechanical expressions include postural shifts like moving closer to the user, and “looking around” in a curious sort of way. The display can also express itself through auditory channels. In the prototype, the auditory expressions, designed to be similar in spirit to the fictional Star Wars Robot R2D2, are non-linguistic but aim to complement the movements, e.g. electronic sounds of surprise. It will be clear that this does not preclude the use of speech synthesis if the task demands it.

The physical animation of the machine is inspired by natural human-human interaction: when people work together, they move in a variety of reciprocal ways, such as shifting posture at conversational boundaries and leaning forward when interested. Physical movement plays an important role in aiding communication, building rapport, and even in facilitating health of the human body, which was not designed to sit motionless for long periods of time. The physically animated display senses and interprets multi-modal cues from the user via custom sensors (including facial and postural expression sensing) and machine learning algorithms (designed to recognize patterns of human behavior from multiple modes). It then responds to the user's cues with carefully crafted subtle mechanical movements and occasional auditory feedback, using principles derived from natural human-human interaction. One of the chief concerns of such a system is that it not be distracting or diminish task performance, since generally the machine will be used like a regular visual display.

In a preferred embodiment, the motor control system is comprised of the physical hardware and the software that controls it. The hardware can be split into two components: the robot (motors, amplifiers, limit switches) and the control hardware (encoders, motor control board, control PC). In the prototype embodiment, the software layer consists of the Motion Programmers Interface (MPI) and a higher-level driver that integrates the motor system with the c5m architecture. The top layer of abstraction in the motor control system is the safety and configuration layer. Behavior system developers concern themselves primarily with this layer.

The physical “RoCo” robot was built by Xitome Inc. It has five degrees of freedom: head yaw, head pitch, head roll, base pitch, and base yaw. The head refers to a mounted LCD screen that displays relevant task information. The motors are brushless DC motors that operate smoothly and quietly to avoid distracting the user. An eight axis analog XMP control card from Motion Engineering Inc. (MEI) is used to interface with the control PC and the robots servoamplifiers. The servoamplifiers are configured for current control mode (i.e. torque control). Encoder feedback goes to the MEI card which handles the position control via software running on the control PC. Because the MEI card expects differential encoders and RoCo has single ended encoders, there is also a bias circuit to provide an appropriate offset as specified in the MEI user manual.

In the “RoCo” prototype implementation, the motor control system is built on top of the Motion Programmers Interface (MPI) API from Motion Engineering Inc (MEI). It controls the actual movement of the motors through an MEI motion control card. It receives joint angle positions from the behavior system that it translates into encoder position counts. Those counts are used to drive the physical motors. Additionally, the motor control system is fully configurable with a plain text configuration file. Based on values in that configuration file, the motor control system is capable of auto calibrating the joints on startup. It also implements both hardware and software based limit switches to prevent RoCo from damaging itself and other objects that might be near it.

The Motion Programmers Interface (MPI) is the API for interfacing with the MEI XMP control card. It is, therefore, the basis for the implementations of meixmp motor and meixmp. MPI is a very flexible, low level API designed to handle nearly every motor system imaginable. It is object oriented and written in C. At its core, MPI and the XMP software architecture is composed of four separate modular objects: Motors, Filters, Axes, and Motion Supervisors.

The Motion Supervisor controls one or more axes of motion. It is the primary interface for handling motion. It also monitors the status of all the axes under its control. An Axis object represents a single physical axis or degree of freedom. Given trajectory information from the supervisor, the Axis object generates the desired path. Each Axis object in turn can map to one or more Filter. A Filter is essentially the feedback control object. It computes the output (usually a voltage level) based on data (usually command positions) from the Axis object. Finally, a Filter maps to a Motor object. Motor objects represent the physical motors themselves and in this architecture behave essentially as I/O objects. They provide input data about the physical motor, such as encoder position counts, the state of limit switches, and status signals. They provide output directly to the physical motors as commanded by the associated Filters and Axes.

Additional MPI objects that the motor system employs are the Event, Notify, and the Event Manager objects. Event objects are accessible through the Event Manager and provide information about an asynchronous event. That information minimally includes the event type and source. Notify objects are used to listen for these events and trigger event handling mechanisms. The Event Manager, as the name implies, manages the interaction of Event and Notify objects. It obtains asynchronous events, generates appropriate Event objects, and dispatches to registered Notify objects. Finally, there is the Control object that represents the control board itself. Every application creates a single Control object per board. A Control object is required to create the other objects. A simple single axis move, thus, requires a fair amount of code, the relevant part of which is shown in Table 1.

TABLE 1

/* Create motion controller object */
*control = mpiControlCreate(controlType, controlAddress);
msgCHECK(mpiControlValidate(*control));
returnValue = mpiControlInit(*control);
msgCHECK(returnValue);
/* Create motion controller object */
*control = mpiControlCreate(controlType, controlAddress);
msgCHECK(mpiControl Validate(*control));
/* Initialize motion controller */
returnValue = mpiControlInit(*control);
msgCHECK(returnValue);
/* Create axis object */
*axis = mpiAxisCreate(*control, axisNumber);
msgCHECK(mpiAxisValidate(*axis));
/* Create motion supervisor object with axis */
*motion = mpiMotionCreate(*control, motionNumber,
/* motion supervisor number */
*axis); /* axis object handle */
msgCHECK(mpiMotionValidate(*motion));
MPIMotionParams params; /* Motion parameters */
return Value = mpiMotionStart(motion, MPIMotionType
TRAPEZOIDAL, &params);
msgCHECK(returnValue);

The motor control software layer builds upon the existing systems in the Leonardo platform, the details of which can be found in chapter 5 of M Hancher, “A motor control framework for many-axis interactive robots,” Masters thesis, Massachusetts Institute of Technology, 2003, which is herein incorporated by reference in its entirety. Briefly, the motor system is designed with abstractions to separate the programmer and the engineer. To support the robot hardware using this motor system library, two new classes have been created: meixmp motor and meixmp, which derive from motor and abstract motor container respectively. These classes interface with the hardware API. The meixmp motor and meixmp classes and provide high level behavior programmers with a simpler and cleaner interface.

The meixmp motor object represents a single one to one mapping configuration of MPI objects: Motion Supervisor to Axis to Filter to Motor. The meixmp motor class thus only represents a subset of configurations that MPI can handle. In this instance, the full flexibility that MPI offers is traded for a simpler, cleaner, and more robust implementation. Future work may wish to extend meixmp motor to handle additional configurations or create separate motor classes for them. The meixmp motor handles the creation and deletion of the low level MPI objects. Because it inherits from the motor object, it also provides a number of high level commands like set target position and get velocity. Using the meixmp motor object, a single axis move becomes much easier. The same single axis move shown in Table 1 can therefore be coded as shown in Table 2.

TABLE 2

// create the motor system using the specified config file
// this creates all the mappings etc... from previous example
motor_system main_roco(config_file);
// set the target positions to perform the move
for(motor_system::iterator i=roco->begin( ); i!=roco->end( ); ++i) {
i->set_target_position(position);
}

The meixmp motor object is a low level driver for controlling a single axis. To control a collection of motors the system also provides an meixmp object. It extends the abstract motor container class from Leonardos system and represents a mid-level driver for controlling multiple motors. It spawns a separate thread that runs the actual control code and communicates with the hardware. The meixmp module wraps the MPI Control object. The meixmp module is responsible for creating, destroying, and maintaining the individual meixmp motors in the system. This module also creates and manages an Event Manager object, which as described previously, generates event objects for enabled event sources.

When the meixmp module starts up, it loads the appropriate configuration file and creates all the meixmp motor objects as specified. Once all of the meixmp motor objects have been created, the module enters its auto calibration phase where it discovers the limits of each motor and moves them to their origins. The details of this auto calibration phase are described in the next section. After auto calibration, the module spawns a main thread of execution. In the main thread, the meixmp module continually polls the event manager and motors for critical error events such as limit and position errors. It also tries to move the motors to their target positions. Actual movement commands for the motors, on the high level, are sent by the behavior system via IRCP. On the low level they are handled by callbacks. The main thread also waits for a termination signal after which it disables all of the motors it controls and terminates. A listing of the more important methods in meixmp is shown in Table 3.

TABLE 3

| Function | Description |
|---|---|
| void enable( ) | Enable the joint |
| void disable( ) | Disable the joint |
| void set_target_position(float) | Set the joint's target position |
| void poll( ) | Polls the event manager for events |

Table 4 is a listing of the configuration file roco.dat used to configure the prototype motor control system.

TABLE 4

```
name = “RocoMotorSystem”
description = “RoCo Motor System”
MEIXMP {
  type = “MEIXMP”
  description = “RoCo Controller”
  HeadYaw {
    name = “headRoll”
    description = “head yaw”
    motion_number = 0
    axis_number = 0
    filter_number = 0
    motor_number = 0
    motor_type = 0
    amp_polarity = 1
    pgain = 75
    igain = 2
    dgain = 55
    imax_moving = 0
    imax_idle = 10000
    drate = 7
    range = 43000
    invert_angles = 1
    min_angle = −0.523
    max_angle = 0.523
    pos_hw_action = 3
    pos_hw_polarity = 0
    pos_hw_direction = 0
    pos_hw_duration = 0.1
    neg_hw_action = 3
    neg_hw_polarity = 0
    neg_hw_direction = 0
    neg_hw_duration = 0.1
    velocity = 3000
    acceleration = 5000
    deceleration = 5000
  }
  HeadPitch {
    name = “headNod”
    description = “head pitch”
    motion_number = 1
    axis_number = 1
    filter_number = 1
    motor_number = 1
    motor_type = 0
    amp_polarity = 1
    pgain = 70
    igain = 1
    dgain = 40
    imax_moving = 0
    imax_idle = 10000
    drate = 7
    range = 50800
    invert_angles = 1
    min_angle = −1.2
    max_angle = 0.25
    pos_hw_action = 3
    pos_hw_polarity = 0
    pos_hw_direction = 0
    pos_hw_duration = 0.1
    neg_hw_action = 3
    neg_hw_polarity = 0
    neg_hw_direction = 0
    neg_hw_duration = 0.1
    velocity = 3000
    acceleration = 5000
    deceleration = 5000
  }
  HeadRoll {
    name = “neckPan”
    description = “head roll”
    motion_number = 2
    axis_number = 2
    filter_number = 2
    motor_number = 2
    motor_type = 0
    amp_polarity = 1
    pgain = 70
    igain = 1
    dgain = 50
    imax_moving = 0
    imax_idle = 10000
    drate = 7
    range = 74500
    min_angle = −1.25
    max_angle = 1.25
    pos_hw_action = 3
    pos_hw_polarity = 0
    pos_hw_direction = 0
    pos_hw_duration = 0.1
    neg_hw_action = 3
    neg_hw_polarity = 0
    neg_hw_direction = 0
    neg_hw_duration = 0.1
    velocity = 4000
    acceleration = 5000
    deceleration = 5000
  }
  BasePitch {
    name = “baseTilt”
    description = “base pitch”
    motion_number = 3
    axis_number = 3
    filter_number = 3
    motor_number = 3
    motor_type = 0
    amp_polarity = 1
    pgain = 70
    igain = 1
    dgain = 30
    imax_moving = 0
    imax_idle = 10000
    drate = 7
    range = 51800
    invert_angles = 1
    min_angle = −0.2
    max_angle = 1.1
    pos_hw_action = 3
    pos_hw_polarity = 0
    pos_hw_direction = 0
    pos_hw_duration = 0.1
    neg_hw_action = 3
    neg_hw_polarity = 0
    neg_hw_direction = 0
    neg_hw_duration = 0.1
    velocity = 4000
    acceleration = 5000
    deceleration = 5000
  }
  BaseYaw {
    name = “basePan”
    description = “base yaw”
    motion_number = 4
    axis_number = 4
    filter_number = 4
    motor_number = 4
    motor_type = 0
    amp_polarity = 1
    pgain = 110
    igain = 2
    dgain = 70
    imax_moving = 0
    imax_idle = 10000
    drate = 7
    range = 104118
    min_angle = −1.52
    max_angle = 1.52
    pos_hw_action = 3
    pos_hw_polarity = 0
    pos_hw_direction = 0
    pos_hw_duration = 0.1
    neg_hw_action = 3
    neg_hw_polarity = 0
    neg_hw_direction = 0
    neg_hw_duration = 0.1
    velocity = 4000
    acceleration = 5000
    deceleration = 5000
  }
}
```

Table 5 depicts the motor configuration variables employed in a preferred embodiment of the invention.

TABLE 5

| Variable | Description |
|---|---|
| name | Motor name |
| description | Plain text description |
| motion_number | MPI Motion supervisor number |
| axis_number | MPI Axis number |
| filter_number | MPI Filter number |
| motor_number | MPI Motor number |
| motor_type | MPI Motor type, 0 = servo, 1 = stepper |
| amp_polarity | Amplifier enable polarity, 1 = positive |
| pgain | Proportional gain value |
| igain | Integral gain value |
| dgain | Derivative gain value |
| imax_moving | Max amount of integral gain to use during motion |
| max_idle | Max amount of integral gain to use during idle |
| drate | Derivative gain sampling rate (0-7) |
| range | Encoder range in encoder counts |
| invert_angles | Flag that indicates whether model dof is the inverse of the physical do |
| min_angle | Minimum DOF angle from the model in radians |
| max_angle | Maximum DOF angle from the model in radians |
| pos_hw_action | Specifies the action to take when positive hardware limit is switched |
| pos_hw_polarity | Specifiecs the polarity of the positive hardware limit switch |
| pos_hw_direction | Whether to account for direction when triggering positive hardware switch |
| pos_hw_duration | Minimum amount of time in seconds before switch triggers |
| neg_hw_action | Specifies the action to take when negative hardware limit is switched |
| neg_hw_polarity | Specifiecs the polarity of the negative hardware limit switch |
| neg_hw_direction | Whether to account for direction when triggering negitive hardware switch |
| neg_hw_duration | Minimum amount of time in seconds before switch triggers |
| velocity | Velocity in encoder counts per second |
| acceleration | Acceleration in encoder counts per second squared |
| deceleration | Deceleration in encoder counts per second squared |

Intra Robot Communication System. With the exception of Motor Control to Robot communication, which is done through the MEI control card, all intra-system communication is done over a local area network using the intra-robot communications protocol (IRCP), a custom UDP based protocol developed by the Robotic Life Group [M Hancher, “A motor control framework for many-axis interactive robots,” Masters thesis, Massachusetts Institute of Technology, 2003]. The heart of IRCP is the packet data structure. Each packet contains a robotID, along with source and destination module ids. By convention, each robot on the network claims a unique id. Similarly, each module or system within the robot is claims a unique module id. In principle then, a module can simply transmit its packet over the broadcast address and only the targeted robot and module will accept it. In practice, auto module address discovery can be used to reduce network traffic. The IRCP setup for RoCo is nearly identical to the setup for Leonardo. The details for the IRCP protocol itself can be found in Hancher. RoCo's motor system supports the same set of low-level motion commands as Leonardo, as defined by the IRCP major type 0. These commands are Request Response, Enbable Motors, Disable Motors and Set Target Positions.

At the highest level of abstraction, meixmp motor and meixmp consist of a single configuration file that can be edited by any engineer familiar with motor control systems in order to tweak the performance without recompiling the code. The entire system appears as a collection of familiar variables like velocity and PID coefficients. This convenience arose directly from integrating with Leonardos existing motor system. Part of the configuration file used for RoCo is shown in Table 6.

TABLE 6

```
name = “RocoMotorSystem”
description = “RoCo Motor System”
MEIXMP {
  type = “MEIXMP”
  description = “RoCo Controller”
  HeadYaw {
    name = “headRoll”
    description = “head yaw”
    motion_number = 0
    axis_number = 0
    filter_number = 0
    motor_number = 0
    motor_type = 0
    amp_polarity = 1
    pgain = 75
    igain = 2
    dgain = 55
    imax_moving = 0
    imax_idle = 10000
    drate = 7
    range = 43000
    invert_angles = 1
    min_angle = −0.523
    max_angle = 0.523
    pos_hw_action = 3
    pos_hw_polarity = 0
    pos_hw_direction = 0
    pos_hw_duration = 0.1
    neg_hw_action = 3
    neg_hw_polarity = 0
    neg_hw_direction = 0
    neg_hw_duration = 0.1
    velocity = 3000
    acceleration = 5000
    deceleration = 5000
  }
}
```

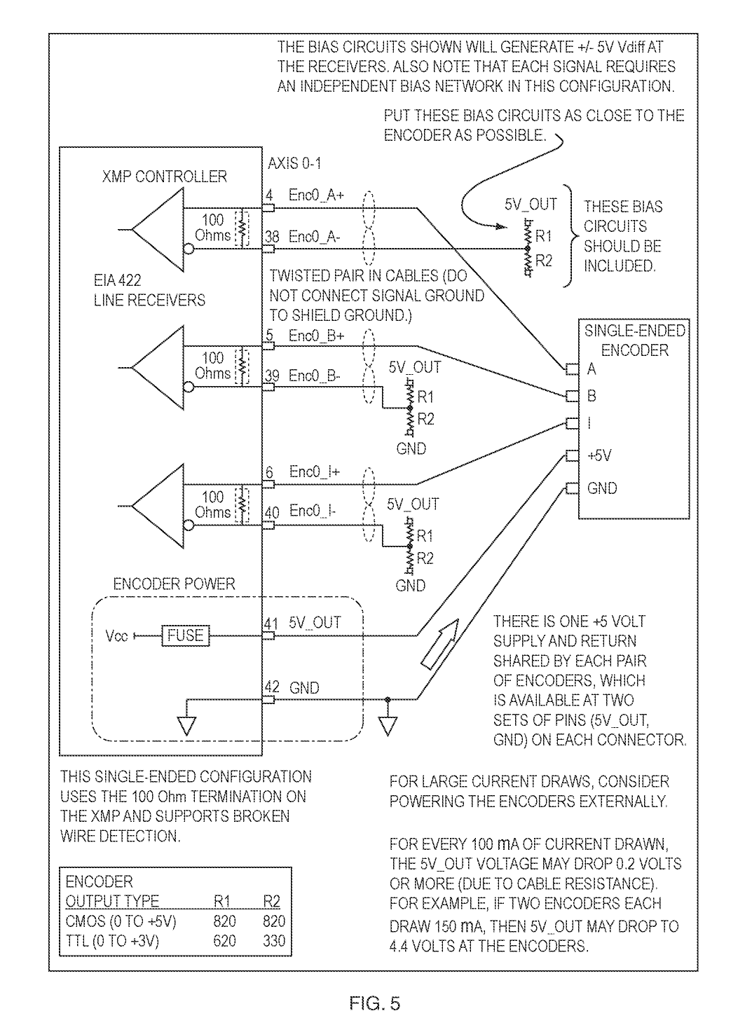

Wiring setup of the prototype embodiment. The MEI control card hardware manual is available online through MEIs website, and is herein incorporated by reference. The encoder signal for each motor must be split between the servoamplifier and the MEI control card. In addition, the MEI control card is designed for differential encoders not single-ended. To adjust for this, there must also be a bias circuit. FIG. 5 is an exemplary depiction of wiring details, as developed for the “RoCo” prototype implementation. As shown in FIG. 5, the prototype implementation uses the TTL bias circuit configuration. Also, the encoders draw power from the servoamplifiers and not the MEI control card. RoCo's limit switches can be configured either in off or on state. That is, off can be considered triggered or not. Off is currently mapped to untriggered. HomeLim Rtn is tied to a 5V Out terminal. The black wire is connected to Gnd and the brown wire is connected to Neg Lim IN or Pos Lim IN depending on which limit switch is being wired. The corresponding terminal numbers are found in Table 7.

TABLE 7

| Pin | Signal | Signal | Pin |
|---|---|---|---|
| 1 | Analog_IN_0+ | Analog_IN_0− | 35 |
| 2 | Analog_IN_1+ | Analog_IN_1− | 36 |
| 3 | Gnd | AGnd | 37 |
| 4 | Enc0_A+ | Enc0_A− | 38 |
| 5 | Enc0_B+ | Enc0_B− | 39 |
| 6 | Enc0_I+ | Enc0_I− | 40 |
| 7 | Home0_IN | 5V_OUT | 41 |
| 8 | Pos_Lim0_IN | Gnd | 42 |
| 9 | Neg_Lim0_IN | HomeLim0_Rtn | 43 |
| 10 | Cmd_Dac_OUT_0+ | Cmd_Dac_Out_0− | 44 |
| 11 | Aux_Dac_OUT_0+ | Aux_Dac_OUT_0− | 45 |
| 12 | Amp_Flt0_IN | Amp_Flt0_Rtn | 46 |
| 13 | Amp_En0_Collector | Amp_En0_Emitter | 47 |
| 14 | UserIO_A0 | UserIO_A0_Rtn | 48 |
| 15 | Xcvr0A+ | Xcvr0A− | 49 |
| 16 | Xcvr0B+ | Xcvr0B− | 50 |
| 17 | Xcvr0C+ | Xcvr0C− | 51 |

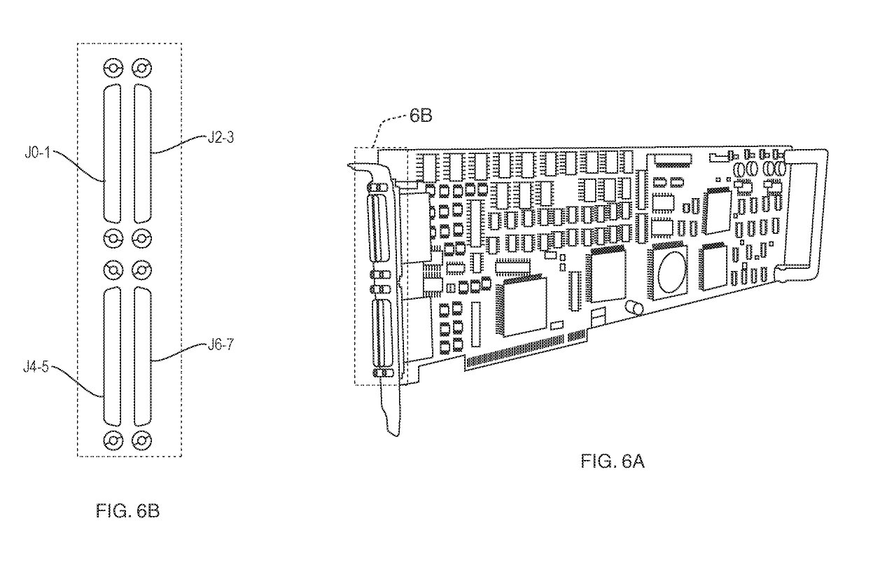

FIGS. 6A and 6B depict an exemplary diagram of the PCI control card, as developed for the “RoCo” prototype implementation. As shown in FIGS. 6A and 6B, in the prototype implementation, the output from the motor control card goes to the servoamplifiers. The Cmd Dac OUT+ and Cmd Dac OUT− are connected to +Set value and −Set value servoamplifier terminals respectively. Additionally, to allow the software to programmatically enable and disable the amplifiers, Amp En Emitter is connected to the Enable input of the amplifier while the Amp En Collector is connected to 5V OUT. A Table 7 provides the corresponding terminal numbers. The Maxon servoamplifiers also require a bit of setup. In order for the servoamplifiers to correctly detect and handle the encoder input, the number of pole-pairs must be set. The only way to set this value is through the RS232 interface and a Maxon provided utility application. This value only needs to be set once. It will be saved across power cycles. Finally, the servoamplifiers should be set in current control mode.

The “RoCo” prototype is also configured with a number of hardware and software safety features that prevent it from damaging itself and other things around it. Hard stops prevent each joint from rotating too far, and limit switches notify the software when a stop has been hit. By default, when RoCo reaches a hard stop, the motor is immediately disabled to prevent it from trying to push through and damaging itself. Software limits can also be set which trigger when the software detects the encoder position has reached a certain point. By default, triggering this event will also disable the motor. This action can be changed through the configuration file. The third safe guard is a position error limit. This is another software safety measure that triggers if the commanded position and the actual position differ more than some specified amount. This measure is used to prevent the motors from trying to push through objects that RoCo might collide with that are in its range of motion.

On startup, RoCo will try to auto-calibrate itself using the information provided in the configuration files. For each joint, RoCo will move until a hard stop is detected. The encoder count at this point is used as a reference point and mapped to the max angle defined in the configuration file. The range, also read from the config file, is used to determine the encoder position of the min angle. The joint then moves to the origin, the 0 angle. If the motor system detects an unexpected error state or starts up in an error state, the auto-calibration sequence will not complete. Instead, the motor system will report the error, disable all motors, and exit. As described, the auto-calibration phase relies on several values in the configuration files that must be predetermined by an engineer. The easiest way of determining encoder ranges is to use the Motion utility provided by MEI. The Motion Console is essentially a GUI for MPI designed for testing and monitoring motion control components. For some motors, disabling them means letting gravity take over, which can cause the joint to fall. The base pitch joint is particularly prone to this.

Cognitive-Affective Control System. In the preferred embodiment, the behavior of the physically animated display is built on top of the C5 behavior architecture system developed at the MIT Media lab [Burke, R., Isla, D., Downie, M., Ivanov, Y., & Blumberg, B., “CreatureSmarts: The Art and Architecture of a Virtual Brain”, Proceedings of the Game Developers Conference, pp. 147-166, San Jose, Calif., 2001; herein incorporated by reference]. This code base has already been developed to create autonomous, animated, interactive characters that interact with each other as well as the user. The architecture is inspired by models of animal behavior and is capable of generating expressive and natural behavior. The C5 behavior architecture was adapted to the task of controlling a physically animated display, using the animation capabilities as a simulator.

In the preferred embodiment, the physical cognitive-affective architecture of the system comprises a Perception System, a Memory System, an Action Selection system, and a Motor System that can output to motor, graphics and sound outputs, as shown in FIG. 1. Each of these systems is responsible for physically implementing aspects of the functionality of the device.

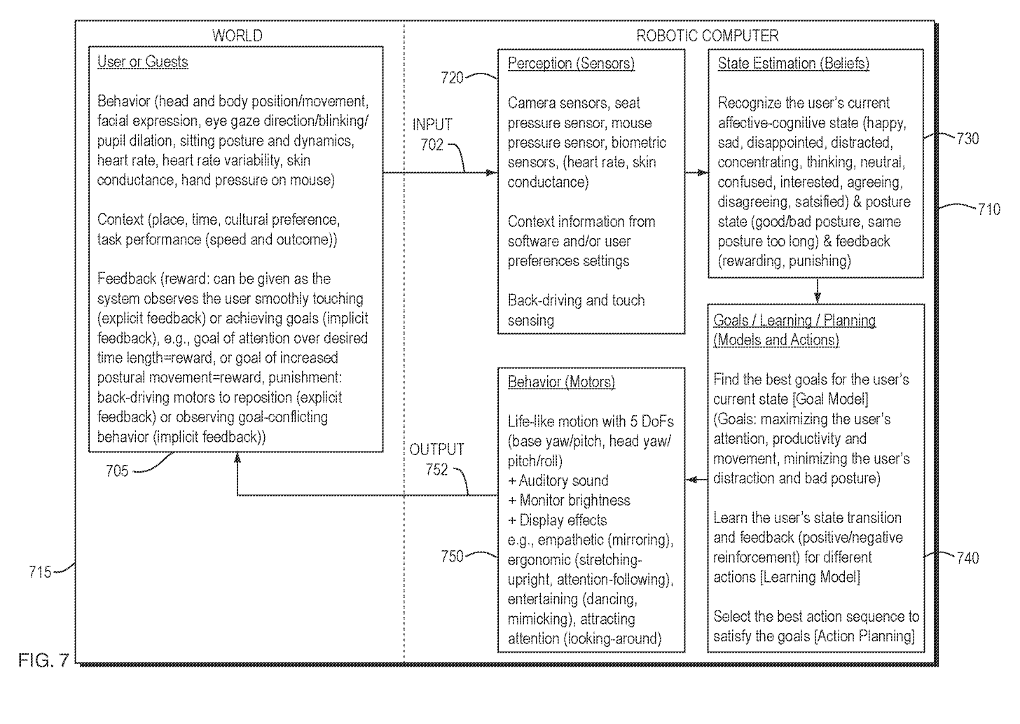

FIG. 7 is a block diagram illustrating the functional design of an embodiment of the cognitive-affective architecture of such a system, divided according to tasks performed. In FIG. 7, as behavior, context, and/or feedback data 702 from user 705 come into robotic computer 710 from the world 715, it is received by perception/sensor subsystem 720. The data obtained by perception/sensor subsystem may include, but is not limited to, data from camera sensors, pressure sensors, and biometric sensors, as well as context information from software and/or user preference settings and from back-driving and touch sensing devices. State estimation subsystem (belief subsystem) 730 recognizes the user's current affective-cognitive and/or posture state, along with any current feedback state, which it provides to models and action subsystem 740 for use in identifying goals for the user's state and for determining which behavioral responses the device should take (e.g. “encourage the user to try again,” “bring the user back on task,” etc.), and in what sequence, in order to best achieve those goals. In a preferred embodiment, models and action subsystem 740 may also employ feedback modeling (learning modeling), in order to more accurately understand how to best motivate individual users to meet the goal. The identified behavioral response instructions are passed to motor subsystem 750, which generates the required motor trajectories and other feedback, including, but not limited to, display animations and effects and sound files and other auditory effects, and sends 752 them to their respective outputs in order to physically animate the device. In a preferred embodiment, the result of these outputs produce behavior that is empathetic (mirroring), attention-attracting (e.g. looking around), entertaining (e.g. dancing, mimicking), and/or ergonomic (e.g. stretching upright, attention-following).

With feedback modeling, the device's behavior patterns and actions adapt over time as the system builds a working memory with the user. The likelihood of taking actions changes based on past interactions and adaptations in the internal motivation system of the system. The system's goal-oriented behavior influences the user's state and feedback, enabling the system to meet such goals as promoting the user's postural movement and good posture, such as by exhibiting stretching-upright behavior when the user keeps a bad posture or doesn't move for a long time, attracting and improving the user's or a guest's attention, such as through mimicking behavior, entertaining behavior, and attention-attracting behavior, and maximizing the user's cognitive performance and subjective comfort and enhancing social rapport through mood-congruent behavior, such as a slumped pose congruent with a user's bad mood or an upright pose congruent with a user's good mood.

As discussed, the C5 architecture consists of a Perception System, a Belief System, an Action System, and a Motor System. The Perception System receives various data from external sensors. It processes that data into a consistent internal format that the other systems can operate on. It then sends the data to the Belief System. The Belief System maintains persistent knowledge about the world. It uses the processed sensory data to update and create knowledge. Stale knowledge eventually gets removed as part of a culling process. The Action System examines the beliefs of the system and determines the next action the agent should take. This process is called triggering. Triggered actions issue the appropriate commands to the Motor System. The Motor System, perhaps more appropriately named the Motor Render System, plays and blends animations for the simulation and also broadcasts joint angle positions to the motor control system. An operator can also possible to manually control the joint positions through a graphical user interface, bypassing the perception, belief, action interaction. This mode of operation is useful for debugging and testing. The Motor System issues its commands over IRCP to the motor control system that actually drives the physical motors.

The motions of the system are based on handcrafted animations to give it a natural and expressive quality of movement (difficult to accomplish with traditional robot control techniques). The motor system blends and layers these animations to make the movement appropriate for the situation at hand [Rose, C., Cohen, M., & Bodenheimer, B., “Verbs and Adverbs: Multidimensional Motion Interpolation,” IEEE Computer Graphics and Applications, 18(5), pp. 32-40, 1998]. For example, the system blends together several animations of the LCD screen posed in different orientations to enable it to direct its attention to a particular person's face.

The “RoCo” prototype implementation was designed to look like an ordinary computer, but to move in ways that are completely paradigm changing. RoCo has no face or body that attempts to evoke humanoid or animal characteristics: it has a regular monitor, keyboard, and box, which are sessile. However, it also has motors that give it smooth, expressive, articulated movement. The five degrees of freedom allow RoCo to perform a wide variety of simple motions, including nodding, shaking its head, and leaning forward. These life-like motions are sufficient to implement a wide variety of immediacy behaviors and postural changes. For example, if the user leans toward RoCo, perhaps to read something tiny on the screen, it can meet the user halfway. At the same time, RoCo has sensors to-monitor user facial and postural movements, so that it does not move in ways that distract the user. Inspired by examining how and when humans move naturally, RoCo can hold very still while the user is attentive to the screen, but looks for natural breaks to maximize the user's movement without distracting or annoying them. For example, if the user has been slumping for a while, and then turn away his gaze, then when he returns his gaze, he might find that RoCo has “stretched” upward, subtly encouraging the user to adjust his posture upward.

In particular, the system is designed to sense those affective and attentive states that play an important role in extended or cooperative tasks. For instance, in an extended learning task, detecting affective states such as interest, boredom, confusion, and excitement is important. A goal is to sense these emotional and cognitive aspects in an unobtrusive way. Cues like posture, gesture, eye gaze, facial expression etc. help expert teachers recognize whether a learner is on-task or off-task. For instance, Rich et al. have defined symbolic postures that convey a specific meaning about the actions of a user sitting in an office such as interested, bored, thinking, seated, relaxed, defensive, and confident [Rich, C., Waters, R. C., Strohecker, C., Schabes, Y., Freeman, W. T., Torrance, M. C., Golding, A., Roth, M., “A Prototype Interactive Environment for Collaboration and Learning”, Technical Report TR-94-06, 1994]. Leaning forward towards a computer screen might be a sign of attention (on-task) while slumping on the chair or fidgeting suggests frustration/boredom (off-task).

The physically animated display system has a sensory system to monitor the user's facial and postural movements so that it can detect and respond to the user's postural, affective and cognitive states. The system tracks the user ergonomically while he or she is attentive to the screen, but also looks for natural breaks to maximize the user's movement without distracting or annoying him or her. Moreover, the display system can take a congruous posture responding to the user's different mood state (e.g., slumping following a failure/sitting up proudly following a success). These kinds of empathetic-appearing responses have been shown to enhance the user's perceived comfort level and persistence in problem-solving tasks and may contribute to better overall user experience. The system can also learn behaviors that are socially important, which may help build trust, liking, rapport, and other qualities that improve the human experience using this technology.

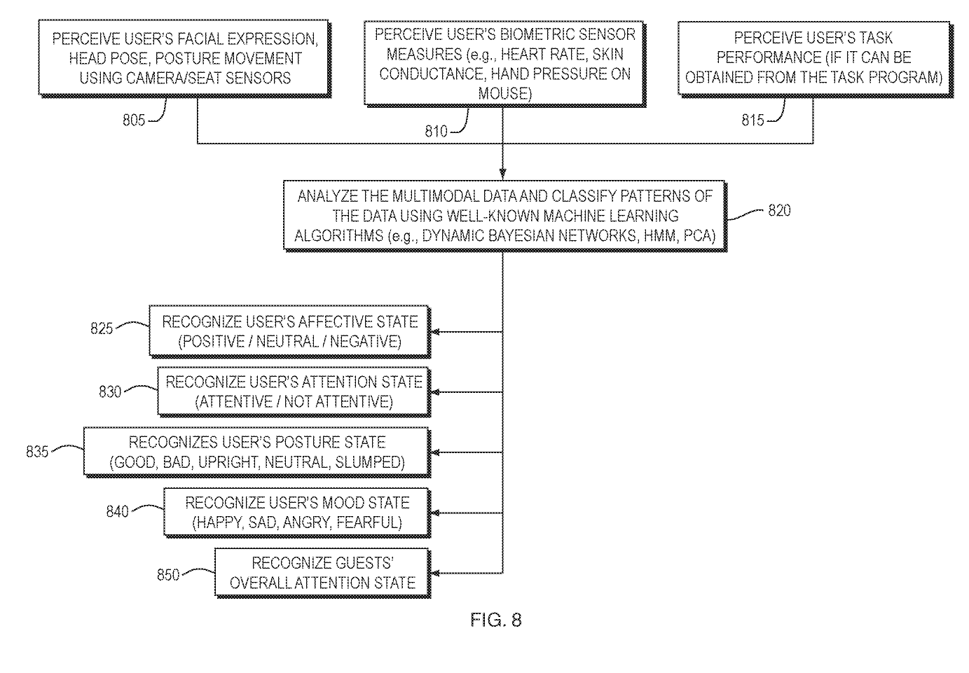

FIG. 8 is a block diagram illustrating an embodiment of the process of recognizing the user's state, according to one aspect of the invention. In FIG. 8, multimodal perceptual data is gathered from and about the user, including data gathered from cameras and seat sensors 805, such as, but not limited to, facial expression, head pose, and posture movement, biometric sensor measures 810, such as, but not limited to, heart rate, skin conductance, and hand pressure on the mouse, and task performance measures 815. The gathered multimodal data is analyzed and patterns classified 820. In a preferred embodiment, this step is performed using any of the many machine-learning algorithms known in the art, including, but not limited to, dynamic Bayesian networks, HMM, or OCA, and/or combinations thereof. Based on this analysis and classification 820, the system can recognize the user's affective state 825 (e.g. positive, neutral, negative), attention state 830 (e.g. attentive, not attentive), posture state 835 (e.g. good, bad, upright, neutral, slumped), or mood state 840 (e.g. happy, sad, angry, fearful), as well as a Guest's overall attention state 850.

In the preferred embodiment, the system also acquires the user's feedback to its behavior, and this feedback influences the system's future behavior. In other words, the system is capable of learning what kind of behavior it should take to satisfy both the user's desires and its own goals, such as promoting healthy movement. Several implicit or explicit signals such as facial expressions, gestures, postural movements, task-related actions through keyboard and mouse, speech, or other physiological or tangible inputs can be used for the user feedback mechanism. Thus, the system can sense and respond to human physical, affective, and cognitive state, using a variety of sensorial inputs coupled with customized machine learning and pattern recognition tools.

The Sensory Input system consists of a number of independent input devices that, in the prototype implementation, include the computer's mouse and keyboard, and a blue eyes pupil tracking system. However, the system is designed to support a wide variety of sensor and input systems that will inform it about the world, in addition to the standard mouse and keyboard. Alternate, or additional, sensory devices that can be used include, but are not limited to, a head pose tracker and a sensor chair. These sensors tell enable the system to model and monitor the user's emotions and attention. From that information, the system can determine appropriate times to change its posture and what optimal posture to adopt. As with the other system modules, each sensory and input device interfaces with the behavior system using IRCP.

One external sensory system supported by the prototype implementation is the Blue Eyes pupil tracking camera built by IBM. An IBM Blue Eyes camera system is mounted on the lower edge of the LCD screen and captures images in real-time for detection. It uses a combination of off-axis and on-axis Infrared LEDs and an Infrared camera to track the users pupils unobtrusively by producing the red eye effect [Haro, A., Essa I., & Flickner, M., “A Non-invasive Computer Vision System For Reliable Eye Tracking”, Proceedings of ACM CHI 2000 Conference, The Hague, Netherlands, 2000; Haro, A., Essa, I., & Flickner, M., “Detecting and Tracking Eyes by Using their Physiological Properties, Dynamics and Appearance”, Proceedings of IEEE Computer Vision and Pattern Recognition, Hilton Head, S.C., 2000]. Additional real time techniques developed by Kapoor and Picard [A. Kapoor and R. Picard, “Real-time, fully automatic upper facial feature tracking”, Proceedings of the 5th International conference on automatic face and gesture recognition, 2002] automatically detect and track other user facial features such as eyes, brows, nose and lips. There is also support for blink and nod detection. This information can be important for determining the user's attention, which serves as a cue for appropriate times to shift the system's posture. Also physiological parameters, such as, but not limited to, pupillary dilation and eye-blink rate, can be extracted to infer information about arousal and cognitive load. The direction of eye gaze is an important signal to assess the focus of attention of the learner. In an “on-task” state the focus of attention is mainly toward the problem the student is working on, whereas in an “off-task” state the eye-gaze might wander off from it.

The pupil locations are determined and sent to the system over IRCP. To improve robustness and reduce variability in reported pupil position, the blue eyes module does some smoothing and filtering. For the last nine points, it does a vote of valid and invalid pupil points (invalid points have negative values). Each vote is weighted linearly according to recentness with the most recent points receiving the most weight. If the system determines that it is indeed detecting pupils, it takes a weighted average of the valid points, again weighted by recentness. This averaged position is sent to the behavior system. The smoothing process introduces a slight delay in tracking of the pupils in return for less variability in the position.

The Blue Eyes System sends left and right pupil positions as a float array of length 4 over IRCP to the behavior system. The array contains in this order: left pupil x position, right pupil x position, left pupil y position, and right pupil y position. The Blue Eyes System introduces a new major type to IRCP, type 6, which is the first unreserved type. Any IRCP compatible systems that are interested in Blue Eyes data should subscribe to major type 6. The pupil information is sent using minor type 0. Additional minor types can be defined for additional data, such as pupil size, eye points, eyebrow points, and nod and blink detector. Currently, the prototype behavior system implements a simple Blue Eyes packet handler that simply receives the pupil data and prints it out.

Color Stereo Vision. In the prototype implementation, a Color Mega-D stereovision system (manufactured by Small Vision Systems, Inc.) is mounted inside the computer's base. This is a compact, integrated megapixel system that uses advanced CMOS imagers from PixelCam, and fast 1394 bus interface electronics from Vitana, to deliver high-resolution, real-time stereo imagery to any PC equipped with a 1394 interface card. It is used to detect and track the movement and orientation of the user's hands and face [Breazeal, C., Brooks, A., Gray, J., Hancher, M., McBean, J., Stiehl, W. D., and Strickon, J., “Interactive Robot Theatre,” Communications of the ACM, 46(7), pp. 76-85, 2003]. This vision system segments people from the background and tracks the face and hands of the user who interacts with it. FIG. 7 is a snapshot of the output of the stereovision system that is mounted in the base of the computer. Motion is detected in the upper left frame, human skin chromaticity is extracted in the lower left frame, a foreground depth map is computed in the lower right frame, and the faces and hands of audience participants are tracked in the upper right frame.

Relatively cheap algorithms have been implemented for performing certain kinds of model-free visual feature extraction. A stereo correlation engine compares the two images for stereo correspondence, computing a 3-D depth (i.e., disparity map) at about 15 frames per second. This is compared with a background depth estimate to produce a foreground depth map. The color images are simultaneously normalized and analyzed with a probabilistic model of human skin chromaticity to segment out areas of likely correspondence to human flesh. The foreground depth map and the skin probability map are then filtered and combined, and positive regions extracted. An optimal bounding ellipse is computed for each region. For the camera behind the machine facing the user, a Viola-Jones face detector [Viola, P. & Jones, M., “Rapid Object Detection Using a Boosted Cascade of Simple Features”, Proceedings of the IEEE Conference on Computer Vision and Pattern Recognition, Kauai, Hi., pp. 511-518, 2001] runs on each to determine whether or not the region corresponds to a face. The regions are then tracked over time, based on their position, size, orientation and velocity. Connected components are examined to match hands and faces to a single owner.

Additional useful sensory systems include, but are not limited to, a head pose tracker, a sensor chair and a mouse pressure sensor. The head pose tracker is used to track the orientation of the users face, information that is difficult to obtain from the Blue Eyes system. When used in combination with the Blue Eyes camera, the head pose tracker provides additional cues for the users attention and focus. Similarly, the sensor chair not only provides posture data for healthful movement applications, but it can also provide information on affective states such as high and low interest levels or even pride and disappointment. Changes in posture will also signal appropriate times for the system to change its posture as well.

A postural sensing system has been developed with custom pattern recognition that watched the posture of children engaged in computer learning tasks, and learned associations between their postural movements and their level of high interest, low interest, or “taking a break” (a state of shifting forward and backward, sometimes with hands stretched above the head, which tended to occur frequently before teachers labeled the child as bored.) The system attained 82% recognition accuracy training and testing on different episodes within a group of eight children, and performed at 77% accuracy recognizing these states in two children that the system had not seen before [Mota, S., “Automated Posture Analysis for Detecting Learners Affective State”, MS Thesis, MIT Media Lab, Cambridge Mass., 2002; Mota, S. and Picard, R. W., “Automated Posture Analysis for Detecting Learner's Interest Level”, 1^{st} IEEE Workshop on Computer Vision and Pattern Recognition, CVPR HCI 2003, 2003]. The system may thus use postural cues to decide whether it is a good time to encourage the user to take a break and stretch or move around. Specifically, focus has been on identifying the surface level behaviors (both indicative of attention and affect) that suggest a transition from an on-goal state to off-goal state or vice versa.

In some embodiments, the user sits in a sensor chair that provides posture data from an array of force sensitive resistors—similar to the Smart Chair used by Tan et al. [Tan H. Z., Ifung, L. & Pentland A., “The Chair as a Novel Haptic User Interface”, Proceedings of the Workshop on Perceptual User Interfaces, Banff, Alberta, Canada, October 1997]. In a preferred embodiment, it consists of two 0.10 mm thick sensor sheets, with an array of 42-by-48 sensing units. Each unit outputs an 8-bit pressure reading. One of the sheets is placed on the backrest and one on the seat. The pressure distribution map (2 of 42×48 points) sensed at a sampling frequency of 50 HzA custom pattern recognition system was developed to distinguish a set of 9 static postures that occur frequently during computer learning tasks (e.g., lean forward, lean back, etc.), and to analyze patterns of these postures over time in order to distinguish affective states of high interest, low interest, and taking a break. These postures and associated affective states were recognized with significantly greater than random accuracy, indicating that the postural pressure cues carry significant information related to the student's interest level [Mota, S. and Picard, R. W., “Automated Posture Analysis for Detecting Learner's Interest Level”, 1^{st} IEEE Workshop on Computer Vision and Pattern Recognition, CVPR HCI 2003, 2003].

A mouse has been modified into a mouse pressure sensor in order to sense not only the usual information (where the mouse is placed and when it is clicked) but also how it is clicked, the adverbs of its use. It has been observed that users apply significantly more pressure to the mouse when a task is frustrating to them than when it is not [Dennerlein, J. T., Becker, T., Johnson, T., Reynolds, C., and Picard, R. W., “Frustrating Computer Users Increases Exposure to Physical Risk Factors”, Proceedings of International Ergonomics Association, Seoul, Korea, 2003]. In some embodiments, the traditional computer mouse may be replaced with this pressure mouse, and its data combined with that from the other sensors to learn about the user state.

In addition to the physical synchronization of data from the sensors described above, algorithms integrate these multiple channels of data for making joint inference about the human state. In one embodiment, recent techniques in machine learning based on Bayesian combination of “experts” are employed. These techniques use statistical machine learning to learn multiple classifiers, and to learn how they tend to perform given certain observations. This information is then combined to “learn” how to best combine their outputs to make a joint decision. The techniques used generalize those of Miller and Yan [Miller, David J. and Yan, Lian, “Critic-Driven Ensemble Classification”, Signal Processing, 47 (10): 2833-2844, 1999] and so far appear to perform better than classifier combination methods such as the product rule, sum rule, vote, max, min, and so forth [Kapoor, A., Ivanov, Y., and Picard, R. W., “Probabilistic Combination of Multiple Modalities to Detect Interest”, 2004]. These methods are improved upon by using better approximation techniques for the critics and their performance, as well as by integrating new techniques that combine learning from both labeled and unlabeled data (semi-supervised, with the human in the loop).

The system of the present invention has specifically been designed with extensibility in mind. For example, because its input system is designed around IRCP, the prototype RoCo can support over 200 additional input sensors. Furthermore, RoCo's behavior system, the c5m architecture, is another highly extensible system for social behavior. It will be clear to one of skill in the art that, while specific hardware and software was employed in the prototype implementation described here, any of the specific design choices made herein could be replaced with equivalent choices, such as, but not limited to, a different API card, motion controller card, facial feature tracker, or face detector.

The present invention is designed to lie within a continuum that might be loosely described as having ordinary fixed (or hand-adjustable, but then static) desktop computers at one end, and humanoid robots at the other end. In between is a huge space, where things in the office environment that usually do not move on their own can be animated, such as, but not limited to, computers and chairs. One potential benefit from the system's introduction of increased postural movement into computer use is reduced back pain, where physical movement is recognized as one of the key preventative measures. In addition, a user study has shown that the system's physical interactions with its user's affective and cognitive states can improve persistence during a challenging task and enhance ergonomic factors such as comfort. Many other human experience benefits are anticipated as the system's movements are customized to different uses.

Applications range from traditional desktop use with improved ergonomics and experience, to more engaging automated tutoring systems for school children, to more entertaining kiosks in malls, to more sociable “video teleconferencing partners” sitting around the table during a videoconference (the system can, for example, turn its head and convey numerous social cues in place of the remote attendee) applications where having the user develop a social rapport with the computer is beneficial. These applications include establishing a long-term relationship between the user and the computer to effect behavioral change, such as serving as a learning companion for a child, or a robotic assistant for elderly, or helping someone maintain an exercise program.

One motivation for building a physically animated system is the development of applications that benefit from establishing a kind of social rapport with the system. For example, theory and tools for the construction of a computerized learning companion are being developed, which would try to help a child to persist and stay focused on a learning task, and which could mirror some of the child's affective states to increase awareness of the role that these states play in propelling the learning experience. For example, if the child's face and posture show signs of intense interest in what is on the screen, the computer would hold very still so as to not distract the child. If the child shifts her posture and glances in a way that shows she is taking a break, the computer might do the same, and may note that moment as a good time to interrupt the child and provide scaffolding (encouragement, tips, etc.) to help the learning progress. In doing so, the system not only acknowledges the presence of the child and shows respect for her level of attentiveness, but also shows subtle expressions that, in human-human interaction, are believed to help build rapport and liking [La France, M., “Posture Mirroring and Rapport”, In M. Davis (ed.), Interaction Rhythms: Periodicity in Communicative Behavior, pp. 279-298, New York, Human Sciences Press, Inc., 1982]. By increasing likeability, a goal is to make the system more enjoyable to work with and potentially facilitate measurable task outcomes, such as how long the child perseveres with the learning task. It is believed, for example, that a physically animated computer that uses these immediacy behaviors, especially close proximity, direct orientation, animation and postural mirroring, in order to demonstrate liking of the user and engagement in the interaction will lead to increased trust and liking of the computer relative to a computer that does not exhibit these behaviors.

Other types of nonverbal behavior that can potentially increase the naturalness of the human-computer interaction and build rapport include interactional and framing behaviors. Interactional behaviors—those used to regulate the structure of an interaction—include turn-taking cues such as gaze, intonation and whether an interlocutor's hands are in gesture space or not [Duncan, S., “On the Structure of Speaker-Auditor Interaction During Speaking Turns”, Language in Society, 3, 161-180, 1974; Goodwin, M., “Shifting Frame”, In D. Slobin & J. Gerhardt & A. Kyratzis & J. Guo (Eds.), Social Interaction, Social Context, and Language: Essays in Honor of Susan Ervin-Tripp, 1996). Many of these behaviors can be performed by the proposed physically animated computer, even though it is not being designed to use hand gestures or facial displays. Head nods can still be enacted through vertical motion of the monitor, and are used in human-human conversation for acknowledgement, grounding [Clark, H. H., “Arenas of Language Use”, Chicago, Ill., University of Chicago Press, 1992], feedback requests [Heath, C., “Talk and Recipiency: Sequential Organization in Speech and Body Movement”, In J. M. Atkinson & J. Heritage (Eds.), Structures of Social Action, pp. 247-265, Cambridge, Cambridge University Press, 1984], greeting [Kendon, A., “A Description of Some Human Greetings”, Conducting interaction: Patterns of behavior in focused encounters, pp. 153-207, Cambridge, Cambridge University Press, 1990], and emphasis. Gaze away behavior can be enacted through horizontal or diagonal motion of the monitor, and can be used for natural turn-taking cues (e.g., gazing away from listener at turn boundary to keep the turn).

One of the most important interactional behaviors that can be enacted by the physically animated display is the posture shift (gross movements of trunk or limbs), used to signal topic shifts in human-human conversations. In a recent study of human monologues and dialogues, it was determined that speakers tended to shift posture an order of magnitude more frequently at topic boundaries than within topics [Cassell, J., Nakano, Y., Bickmore, T., Sidner, C., & Rich, C., “Non-Verbal Cues for Discourse Structure”, Association for Computational Linguistics, 2001]. One hypothesis about why people do this is that they may be purposefully holding still during delivery of a logical unit of information so as to not unintentionally convey information or distract the listener with superfluous body motion, but as soon as the unit is complete they relax and shift posture. Similarly, the physically animated display needs to be still while the user is performing a unit of work (so that the screen is readable). However, when the task is complete the human and the machine can signal this by shifting position.

Frame changes are similar to topic shifts, but carry even more information about the type of interaction that is being initiated. One view of interactional frames is that they represent what people think they are doing when they talk to each other (e.g., small talk vs. negotiation vs. job interview [Tannen, D., “What's in a Frame? Surface Evidence for Underlying Expectations”, In D. Tannen (Ed.), Framing in Discourse, pp. 14-56, New York, Oxford University Press, 1993]). Gumperz described this phenomenon (he called contextualization) as exchanges representative of socio-culturally familiar activities, and coined “contextualization cue” as any aspect of the surface form of utterances that can be shown to be functional in the signaling of interpretative frames [Gumperz, J., “Sociocultural Knowledge in Conversational Inference”, In M. Saville-Troike (Ed.), Linguistics and Anthroplogy, pp. 191-211, Washington DC, Georgetown University Press, 1977]. Some examples of contextualization cues include emotional displays, smiling, laughing and posture shifts [Goodwin, M., “Shifting Frame”, In D. Slobin & J. Gerhardt & A. Kyratzis & J. Guo (Eds.), Social Interaction, Social Context, and Language: Essays in Honor of Susan Ervin-Tripp, 1996].

Most conversational systems developed to date operate in a single, task-oriented interactional frame, and thus do not need to represent multiple frames nor worry about how frame changes are signaled. However, as machines begin to enter the world of social interaction, they need the ability to clearly signal to the user when a change between frames has occurred. At a minimum, the physically animated display should therefore have the ability to signal when it thinks it is currently engaging the user in task interaction (at attention, rigid, serious) vs. when it thinks the user is off-task, for example taking a break or playing with the computer (animated, playful) vs. when it is coaching the user through a stretching exercise (slow, deliberate motion).

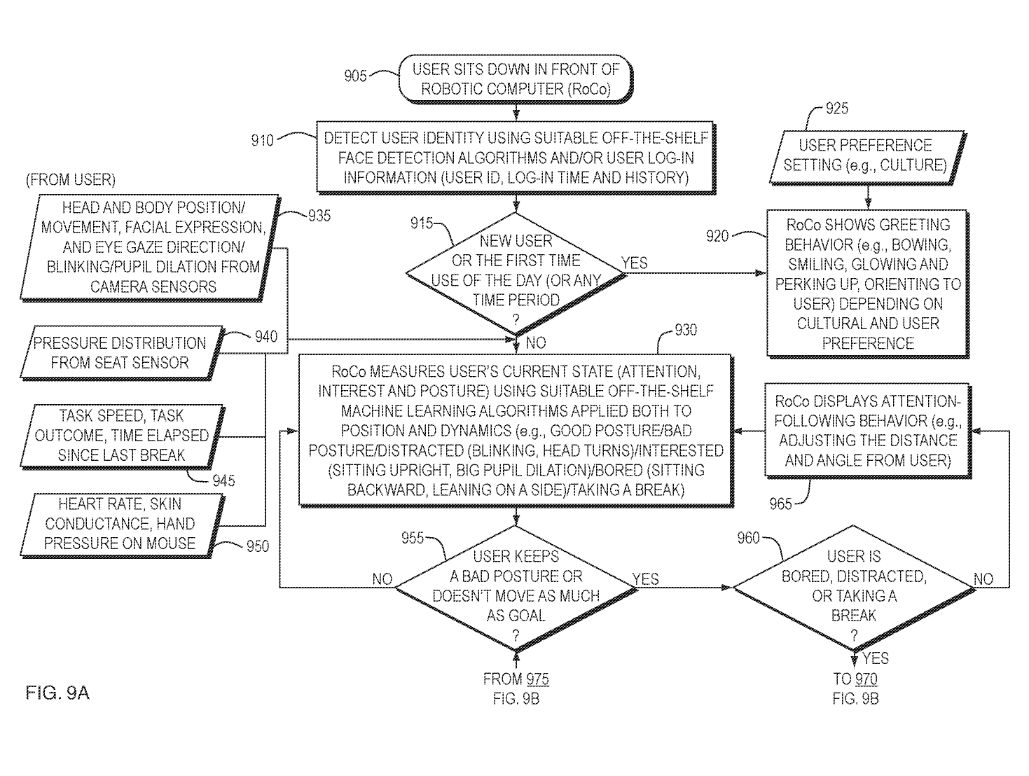

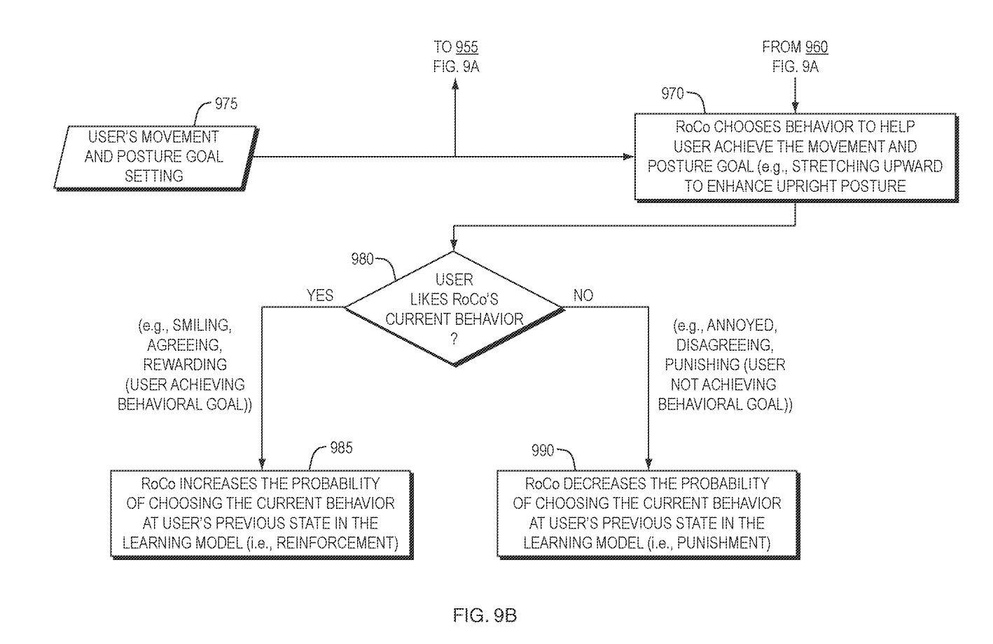

A particular advantage of the physically animated visual display described herein is its adaptability for specific uses, including, but not limited to, improvement of a user's posture, emotional state, cognitive performance, and attention. FIGS. 9A and 9B depict a flowchart outlining an embodiment of a methodology for improving a user's postural movement and overall posture, according to one aspect of the invention. As shown in FIGS. 9A and 9B, when a user sits down in front of the physically animated visual display 905, the system detects the user's identity 910 and determines whether or not the user is new or it is the user's first use during a particular time period 915. If so, the system exhibits “greeting behavior” 920, which may optionally be controlled by user preference setting 925. The system then monitors 930 the user's current attention, interest, and posture state, based on data from camera sensors 935, pressure distribution seat sensors 940, task accomplishment detection devices 945 and/or biometric sensors 950. If the user keeps a bad posture for too long a period 955, or fails to change posture within a goal period, the system assesses 960 whether the user is bored, distracted, blinking, or taking a break. If not, the system displays 965 attention-following behavior, such as adjusting the distance and angle of the display from the user. Otherwise, the system chooses and exhibits 970 a behavior, such as stretching upward to enhance upright posture, designed to help the user achieve the user's movement and posture goal 975. The system then assesses whether the user likes the current behavior 980. If so, the system increases 985 the probability of choosing the current behavior (reinforcement), otherwise it decreases 990 the probability.

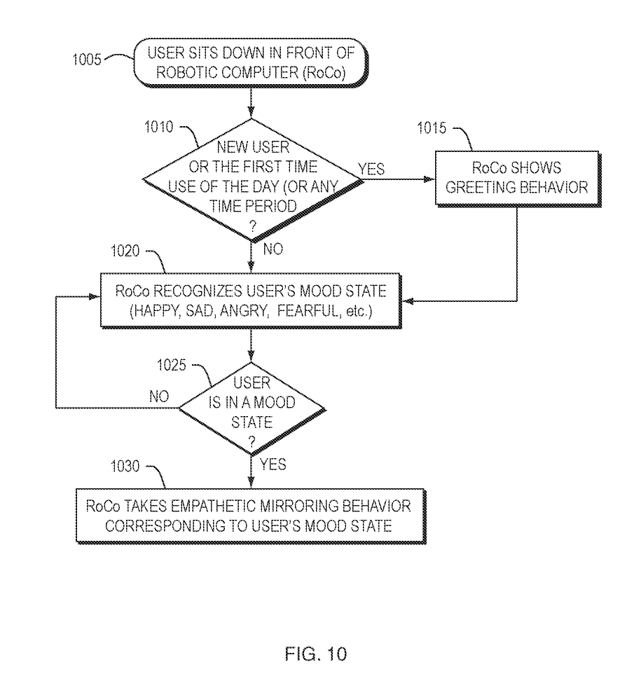

FIG. 10 is a flowchart outlining an embodiment of a methodology for improving a user's mood state through empathic mirroring behavior, according to one aspect of the invention. As shown in FIG. 10, when a user sits down in front of the physically animated visual display 1005, the system determines whether or not the user is new or it is the user's first use of a particular time period 1010. If so, the system exhibits “greeting behavior” 1015. The system then monitors and recognizes the user's mood state 1020. If the user's mood state can be determined 1025, the system exhibits an empathetic mirroring behavior corresponding to the user's mood state 1030.

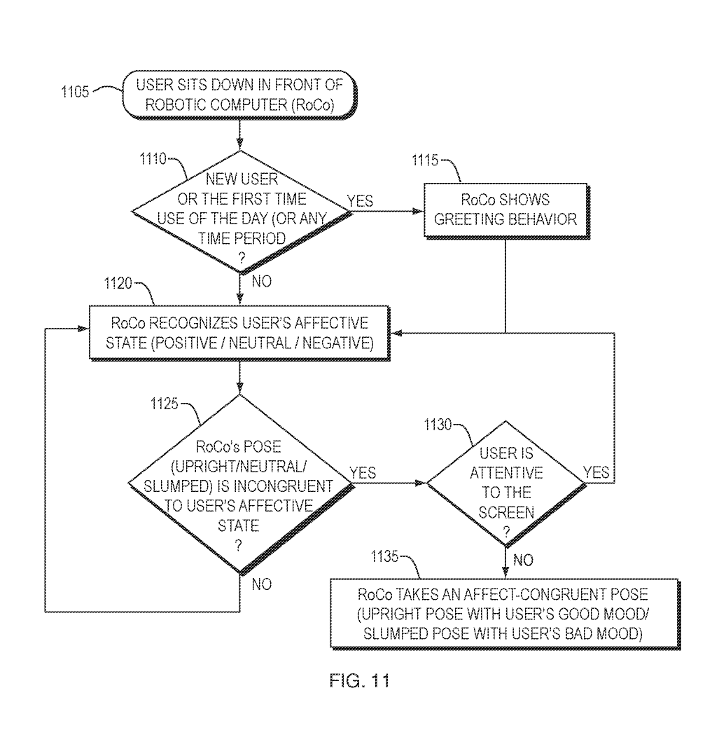

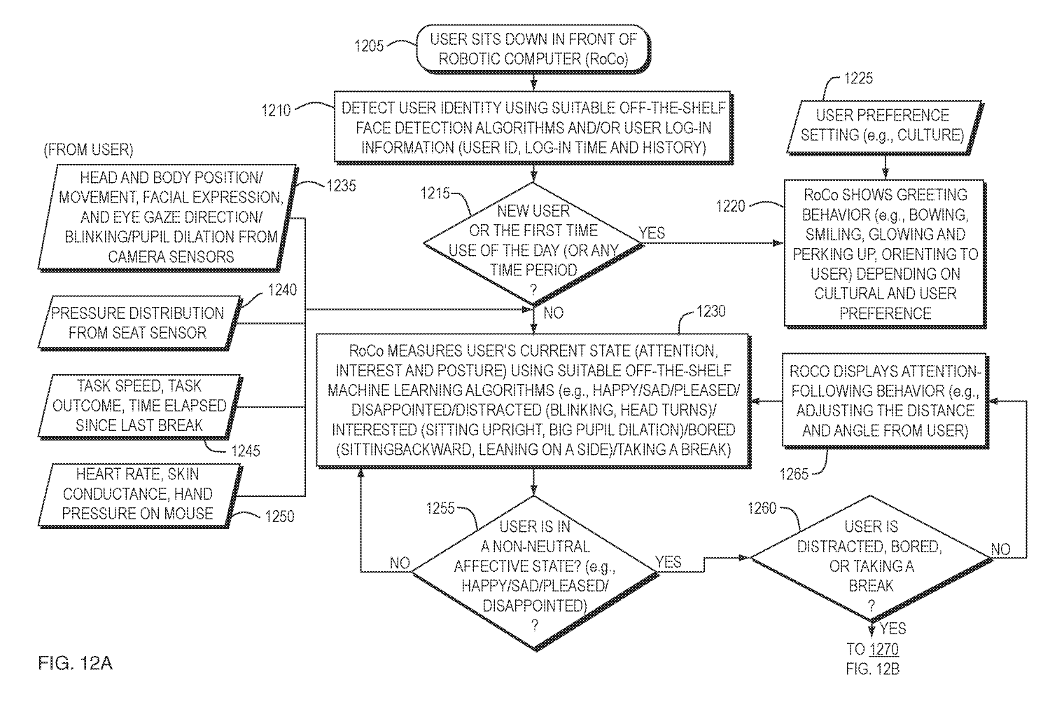

FIG. 11 is a flowchart outlining an embodiment of a methodology for improving a user's cognitive performance, according to one aspect of the invention. As shown in FIG. 11, when a user sits down in front of the physically animated visual display 1105, the system determines whether or not the user is new or it is the user's first use of a particular time period 1110. If so, the system exhibits “greeting behavior” 1115. The system then monitors and recognizes the user's affective state 1120. If the user's pose is incongruent to the user's affective state 1125, and the user is attentive to the screen 1130, then the system exhibits an affective-congruent pose corresponding to the user's mood state 1135, such as, for example, an upright pose to correspond to a user's “good” mood or a slumped pose to correspond to a user's “bad” mood.

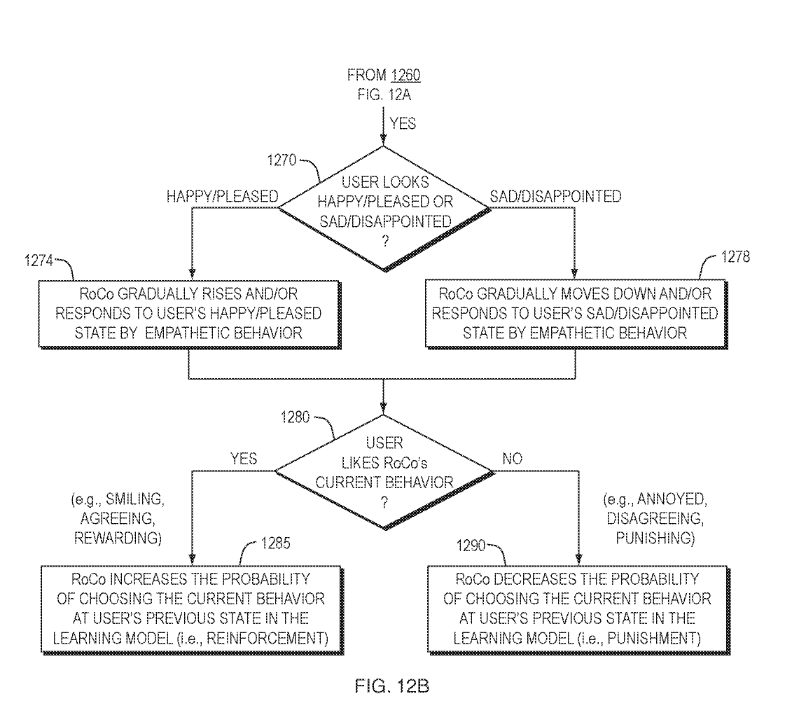

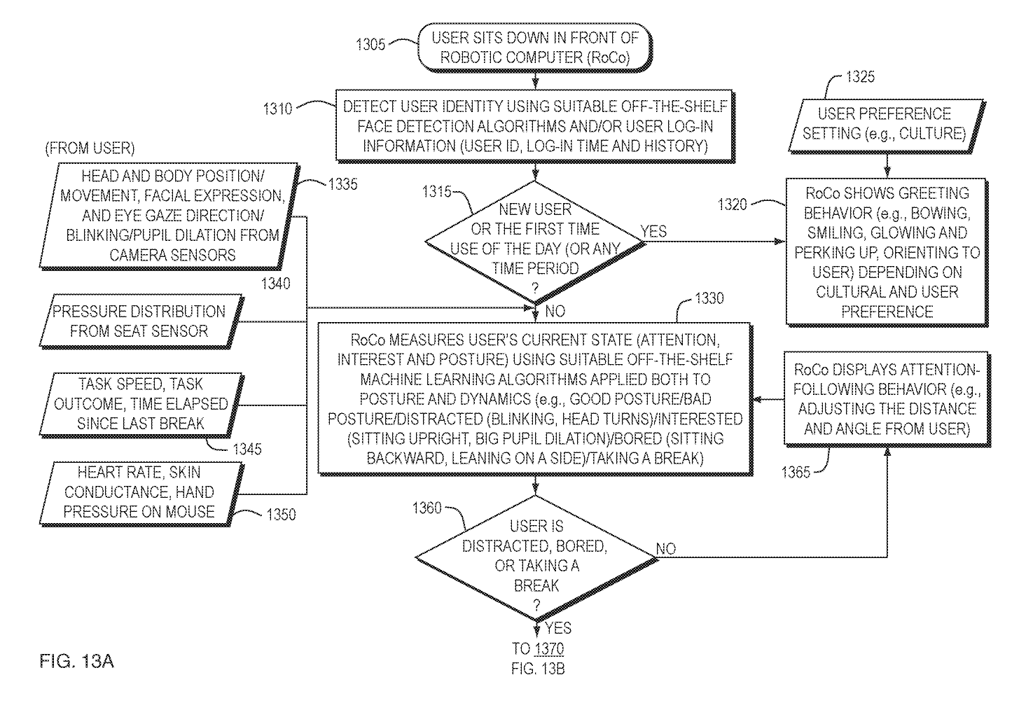

FIGS. 12A and 12B depict a flowchart outlining an embodiment of a methodology for both improving a user's cognitive performance and building social rapport through the affect-congruent posing of the system, according to one aspect of the invention. As shown in FIGS. 12A and 12B, when a user sits down in front of the physically animated visual display 1205, the system detects the user's identity 1210 and determines whether or not the user is new or it is the user's first use during a particular time period 1215. If so, the system exhibits “greeting behavior” 1220, which may optionally be controlled by user preference setting 1225. The system then monitors 1230 the user's current attention, interest, and posture state, based on data from camera sensors 1235, pressure distribution seat sensors 1240, task accomplishment detection devices 1245 and/or biometric sensors 1250. If the user is in a non-neutral affective state 1255, the system assesses 1260 whether the user is bored, distracted, blinking, or taking a break. If not, the system displays 1265 attention-following behavior, such as adjusting the distance and angle of the display from the user. Otherwise, the system determines 1270 whether the user looks happy/pleased or sad/disappointed. If happy/pleased, the system gradually rises and/or exhibits happy/pleased empathetic behavior 1274. If sad/disappointed, the system gradually slumps and/or exhibits sad/disappointed empathetic behavior 1274. The system then assesses whether the user likes the current behavior 1280. If so, the system increases 1285 the probability of choosing the current behavior (reinforcement), otherwise it decreases 1290 the probability.

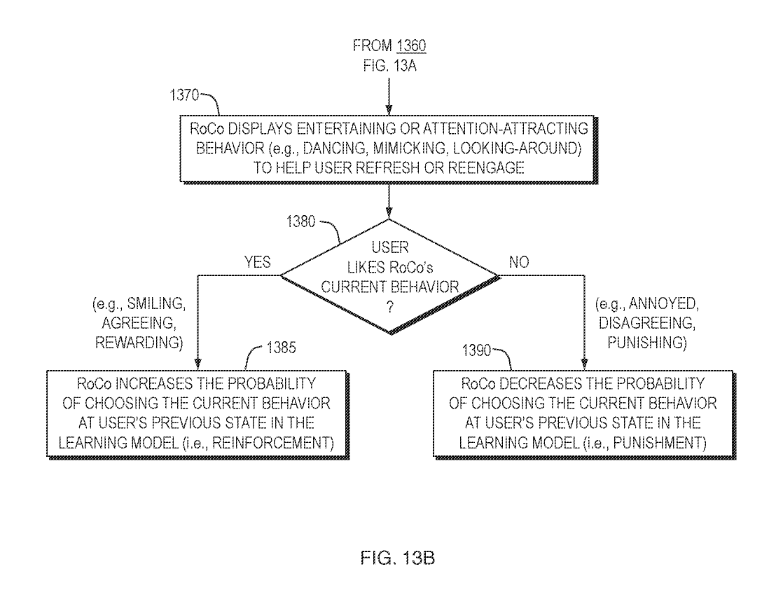

FIGS. 13A and 13B depict a flowchart outlining an embodiment of a methodology for attracting and improving a user's attention state, according to one aspect of the invention. As shown in FIGS. 13A and 13B, when a user sits down in front of the physically animated visual display 1305, the system detects the user's identity 1310 and determines whether or not the user is new or it is the user's first use during a particular time period 1315. If so, the system exhibits “greeting behavior” 1320, which may optionally be controlled by user preference setting 1325. The system then monitors 1330 the user's current attention, interest, and posture state, based on data from camera sensors 1335, pressure distribution seat sensors 1340, task accomplishment detection devices 1345 and/or biometric sensors 1350. The system assesses 1360 whether the user is bored, distracted, blinking, or taking a break. If not, the system displays 1365 attention-following behavior, such as adjusting the distance and angle of the display from the user. Otherwise, the system chooses and exhibits 1370 entertaining or attention-getting behavior, such as, but not limited to, dancing, mimicking, or looking around. The system then assesses whether the user likes the current behavior 1380. If so, the system increases 1385 the probability of choosing the current behavior (reinforcement), otherwise it decreases 1390 the probability.

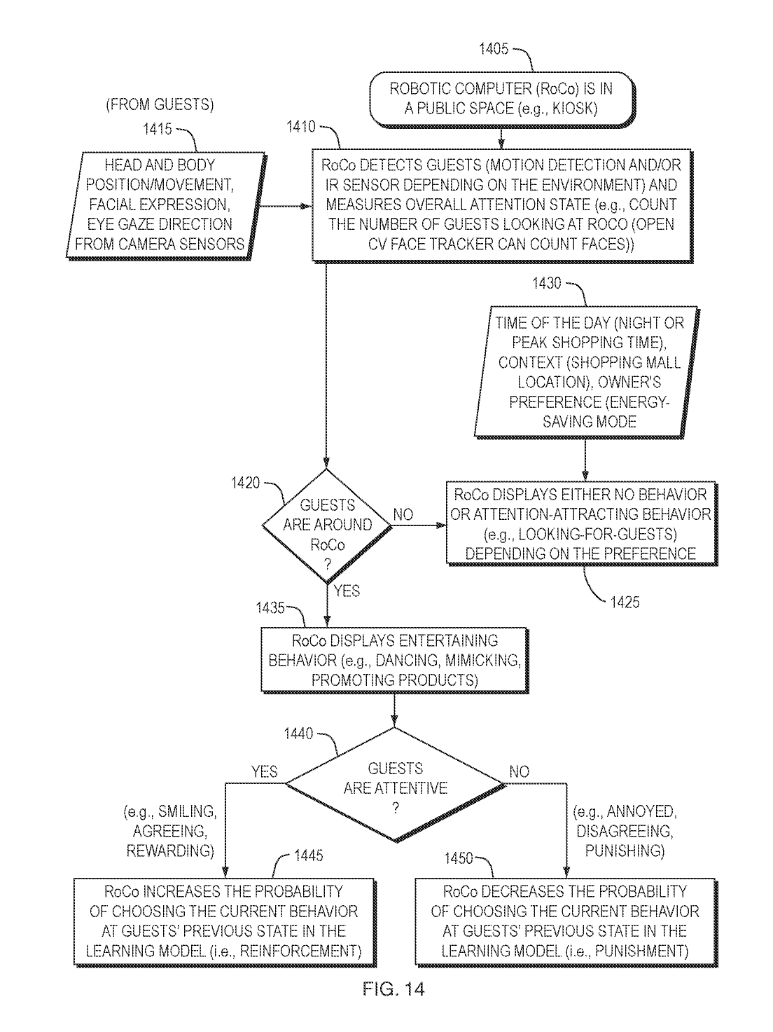

FIG. 14 is a flowchart outlining an embodiment of a methodology for attracting and improving a guest's attention state when the device is in a “public” place with “unknown” users (“guests”), according to one aspect of the invention. As shown in FIG. 14, when the physically animated visual display is located in a public place 1405, the system detects 1410 the presence of guests based on data from camera sensors 1415. If there are no guests standing around it 1420, then the system displays 1425 either no behavior or attention-getting behavior, such as, but not limited to, looking around for guests, depending on 1430 external inputs such as time of day, context, and the owner's preference. If guests are present, the system displays entertaining behavior 1435. If the guests are attentive 1440, the system increases 1445 the probability of choosing the current behavior (reinforcement), otherwise it decreases 1450 the probability.

Preliminary studies have been previously carried out to evaluate the readability of a physically animated computer's subtle expressions [Liu, K. and Picard, R. W., “Subtle Expressivity in a Robotic Computer”, CHI 2003 Workshop on Subtle Expressiveness in Characters and Robots, 2003]. In this preliminary study, 19 subjects watched 15 different video clips of an animated version of the computer and/or heard audio sequences to convey certain expressive behaviors (e.g., welcoming, sorrow, curious, confused, and surprised). The expressive behaviors were conveyed through body movement only—the LCD screen was blank. The subjects were asked to rate the strength of each of these expressions on a 7-point scale for video only, audio only, or video with audio. In a two-tailed t-test, there was significant recognition of the behavior sequences designed to express curiosity, sadness, and surprise.

The experiment framework constructed to facilitate human subject studies using the actual prototype consisted of a number of abstract class and interfaces to simplify the creation of new experiments. The framework is based on the model-view-control design pattern and designed with integration with IRCP packets in mind. Running a user study on the RoCo platform required the development of a flexible experiment framework that allows simple experiments to be readily created and deployed. The experiment framework is platform independent, and it is designed to easily interface with the c5m architecture via IRCP. In this context, an experiment refers to a user experiment, one that has a human subject as the primary agent. The framework follows the Model-View-Controller (MVC) design pattern as a typical experiment lends itself nicely to this approach. The model encapsulates the abstraction of the experiment, while the view provides the user interface, and the controller manages that interaction by calling methods between the view and the model. To support RoCo as a research platform for human subject experiments, an experiment framework in Java has also been developed, which has been tested on a 71-person study.

The Experiment Model supplies all of the experiment logic and data, including instructions and results. The Experiment Model provides a layer between the experiment relevant data and the user interface used by the subject to complete the experiment. From a high level perspective, the Experiment View handles the display of the experiment instructions, tasks, and results, all of which are supplied by the model. The view also publishes user interface events such as mouse clicks and button clicks that other objects, like the controller, can subscribe to. The Experiment Controller handles the interaction between model and the view. It subscribes to the events published by the view and interprets them by calling the appropriate methods in the model. Results objects get created by the Experiment Model and are accessible via the getResults( ) method. They are also available as a parameter of the results available event. The Results object provides a number of views for the underlying data. Views. The Experiment Launcher is an application that allows an experimenter to select and execute an experiment configuration.

The prototype was subjected to empirical studies involving human subjects, in order to fine-tune aspects of the movement and timing within the cooperative learning task domain, and to evaluate the impact of these functions on the user state and on the task performance. Care was taken to identify important user characteristics of the study group such as their amount of computer experience. Such evaluations, involving detailed observational and experimental studies of subjects having significant hands-on time using the physically animated computer, are believed to be the best way to test the human impact of a novel interface. The measures employed went beyond the assessment of likeability and novelty effects to evaluate how movement and subtle expression fosters productivity, healthful movement, and a feeling of bond that facilitates concrete performance outcomes.

Taking advantage of the RoCo research platform, the experiment introduced a different posture manipulation method that allowed the subject to perform dependent measure tasks while in the manipulated posture. Thus, while Riskind measured the effect of a prior posture on a subsequent cognitive task, the effect of the posture was measured concurrent with the task. The expectation was that RoCo would be an effective agent for manipulating posture and inducing the “stoop to conquer” effect. This experiment measured persistence on a helplessness task, creativity on a word association task, and general spatial cognition on a puzzle task as a function of congruous and incongruous postures following affect manipulation.

One potential benefit of introducing increased postural movement into computer use is reduced back pain, where physical movement is recognized as one of the key preventative measures. It is also possible that reciprocal physical movement of affective state during a task leads to improved task measures, such as persistence in problem solving. An initial study with 71 subjects offered promising results in support of the hypothesis that the physically animated visual display's posture not only manipulates the user's posture, but also elicits posture-affect interactions in its user as well.

Seventy-one naive subjects were recruited from MIT and the surrounding area. Subjects were given a $10 gift certificate to Amazon.com as compensation for their participation in the study. Subjects were assigned to one of the six conditions based on the order that they signed up to participate in the study. The first subject was assigned to condition one, the second to condition two, etc. Hence, randomness was achieved through the signup process, which was done through pestering, mailing lists, and boston.craigslist.org. When subjects arrived they were first greeted by the experimenter then led to a standard PC. The experimenter read the following standard set of instructions aloud to the subject: “Please be seated. In front of you is a standard computer setup with mouse, keyboard, monitor and a pen tablet for use in the tracing puzzles. You may arrange these components on the desk any way you like. Please read the instructions carefully as you go. The height of the chair is adjustable with a lever underneath the seat. I will be outside the curtains, if you have any questions or get confused, but in general, please try do as much on your own as possible.” The experimenter then left the area while the subject was shown a two minute video clip previously shown to induce neutral affect [Ray R. Rottenberg, J. and J. J. Gross, “Emotion elicitation using films”, Oxford University Press, New York, N.Y., 2004].

Half of the six conditions involved inducing a feeling of success, while the other half involved inducing a feeling of failure. This was accomplished as follows. Subjects were given a series of four tracing puzzles to solve. They had two minutes to solve each puzzle. To solve a puzzle, the subject must trace over the design without lifting a pen from the puzzle or retracing any lines. In this case, the puzzles were presented on a standard LCD screen and pen tracing is done with a computer pen and tablet input device. The puzzles used are the same set used by Riskind in his studies as well as by Glass and Singer [J. Glass and J. Singer, Urban Stress, Academic Press, New York, N.Y., 1972]. To create a success condition, all four puzzles were solvable. Generally each subject was able to solve at least three out of the four. Unsolved puzzles were usually the result of not carefully reading the instructions beforehand or difficulty using the pen and tablet interface. Regardless of how the subject actually performed, a results chart was displayed and they were told that they scored an 8 out of 10. For the failure condition, the first and last puzzles were unsolvable. The sense of failure was further reinforced by displaying the same results chart as in the success condition except in this case they were told that they scored a 3 out of 10.

Following the success-failure manipulation, the subject's chair was rolled over a few feet to RoCo, the position of which had already been preset to either slumped, upright, or neutral. These positions are shown in FIGS. 4A-C. The subject was seated in the same calibrated chair and asked to perform another series of puzzles, this time on RoCo. The subject was video taped from the side as a manipulation check. The experiment examined three dependent measures: creativity, spatial cognition, and persistence. Subjects were administered these tests in a random order to minimize any effect the order of the tasks might have.

Unsolvable Tracing Task to Test Persistence The subject was given four mathematically unsolvable tracing puzzles with a time limit of two minutes for each. This task assumes that the fewer the number of tries in the allotted time, the lower the subject's tolerance for a frustrating task. Some of the puzzles are the same as those used in Riskind's original study. Additional puzzles were created by transforming some solvable into unsolvable. Debriefings showed that only people who knew the mathematical rule ahead of time for solvability were able to distinguish solvable from unsolvable puzzles (and data from such people was not included in the results).

Remote Associates Test. The subject was asked to complete 14 items of the Remote Associates Test that ranged from easy to hard. Past research has shown that performance on the Remote Associates Test improves with positive affect, although negative affect does not have an adverse effect.

Tangram Puzzle. The subject was given seven minutes to try to solve as many (up to seven) tangram puzzles as possible. Good performance on tangrams has been linked with good spatial cognition. A maximum of seven was chosen since even someone who knew the solutions ahead of time could not complete all seven in seven minutes.

Following the dependent measure tests, the subject was given a full debriefing. As a check on the success-failure manipulation, the subject was asked how well they thought they performed on the first part. All subjects in the failure manipulation responded with answers like “not well”, “below average”, and “ok”, suggesting that the manipulation was successful. Similarly, most subjects in the success case responded with answers such as “well” and “above average”. Four subjects in the success condition who had trouble with the tracing puzzles in part one did report that they did not do well. Their results have been discounted since the manipulation was not successful for them. Following the manipulation check, the details of the study were disclosed including the impossibility of some of the tracing puzzles and the fabricated test results in part one. Four subjects also reported at this time that they knew the tracing puzzles were mathematically impossible. Their results for the tracing puzzles were similarly discounted.

A two-way analysis of variance (ANOVA) on the persistence on the insolvable puzzles data showed no main effects for either the success-failure or the posture manipulations, F (2, 57)<2, p<0.2 and F (2, 57)<3, p<0.07 respectively. Promisingly, the analysis did reveal a statistically significant interaction effect, F (2, 57)=4.1, p<0.05. These results are consistent with Riskind's findings. Further simple effects analysis by success-failure outcome revealed that success subjects exhibited more persistence when they used RoCo in its upright position (M=11.97) after their success than when they used RoCo in its neutral position (M=8.32), or in its slumped position (M=8.15), F (2, 57)=7, p<0.01. However, unlike Riskind's study, failure subjects showed no statistical difference across postures, F (2, 57)=0.1. The discussion section will hypothesize a few explanations for this difference.

ANOVA analysis of self-reported comfort levels shows a significant posture main-effect, F (2, 62)=4.12, p<0.02. As one would expect, slumped postures are rated as less comfortable. Surprisingly, in the failure-upright case, comfort levels were as low as the slumped posture conditions. A possible explanation is that the natural tendency to slump following failure was in conflict with the monitor position's influence on them to sit more upright. This might have made an otherwise comfortable upright position uncomfortable.

This research has advanced a new theory and developed new algorithms and tools for non-invasively sensing, recognizing, and responding to a child's emotional state in a computer learning situation. Results include: (1) developing a system to gather and synchronize data from multiple sensors, including two custom sensors (BlueEyes Camera and TekScan Chair pressure sensor); (2) crafting a computer learning interaction that reliably elicited both boredom and different levels of interest, and collecting five channels of synchronized data from twenty children engaging in this interaction; (3) developing, through iterative work with teachers, a set of emotion labels that could be reliably and meaningfully attached to this data, and having the data coded with these labels: “high interest,” “medium interest,” “low interest,” “taking a break,” and “bored;” and (4) developing and testing automated pattern recognition/machine learning algorithms for enabling the computer to infer these labels, and achieving highly significant recognition rates on upper facial expressions and on shifts in posture related to affective state; thus, showing that machines can recognize, with significantly higher than chance probabilities, indications of the learner's affective state related to interest and boredom.

In parallel with this effort, tools have been developed for building agents that would respond to the learner's affective state. New “relational agents,” agents capable of building long-term social-emotional relationships with people, have been designed, built, and tested. A 99-person one-month test of the first relational agent, where subjects were split into three groups, all doing the same task (⅓ with no agent, ⅓ with the relational agent, ⅓ with the same agent but without its relational skills) and found the task outcome improved in all cases, while a “bond” rating toward the agent was significantly higher in the relational case. Thus, this work showed that certain relational skills could be automated, resulting in people reporting that the agent cared more about them, was more likeable, showed more respect, and earned more of their trust than the non-relational agent. People interacting with the relational agent were also significantly more likely to want to continue interacting with that agent. The significant difference in people's reports held at both times of evaluation: day 7 and day 27, showing that the improvement was sustained.

In one aspect, the invention may be embodied in a physically animated computer that engages the user with natural, multi-modal, socio-emotive cues. In another aspect, the invention embodies a set of principles for how to effectively use subtle physical movement of a computer to improve the quality of interaction with the machine. The technology has the potential for great impact in the design of human-machine interfaces. Examples include the design of intelligent, physically animate interfaces that foster healthful computer use behaviors (improved posture, increased movement, etc.) without being distracting; the design of educational technologies (e.g., tutorial and training software or robots) that recognize and respond to the attentional and affective cues of the learner to enhance the learning experience; and the design of relational agents, either robotic or animated technologies that engage the user in a long-term relationship to help the user effect behavioral change, by building social rapport and a greater sense of trust, bonding, and likeability.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A physically-animated apparatus for improving a user's current attention, cognitive performance, or emotional state, comprising:
a robotic device capable of multiple degree-of-freedom motion; and
an affective-cognitive system, comprising:
a feature extraction subsystem, adapted for deriving physical information about a user from data obtained from at least one device configured for sensing current physical state data about the user;
a perception subsystem, adapted for processing the physical information received from the feature extraction subsystem in order to determine the user's current emotional or affective-cognitive state;
an action selection subsystem, adapted for determining an action to be taken in response to the determined emotional or affective-cognitive state; and
a motor system, the motor system comprising at least one device adapted to physically animate the robotic device in accordance with the determined action.

2. The apparatus of claim 1, wherein the action selection subsystem is further adapted for feedback modeling based on a reaction of the user to the movement of the apparatus.

3. The apparatus of claim 1, further comprising at least one of a graphical display or an audio output.

4. The apparatus of claim 1, further comprising at least one seat sensor, blue eyes camera, stereo camera, or microphone.

5. The apparatus of claim 1, wherein the physical state data comprises at least one of facial expression, head pose, posture movement, biometric sensor measures, hand pressure on a computer mouse, and task performance measures.

6. An apparatus for improving a user's physical comfort level, comprising:
a robotic device capable of multiple degree-of-freedom motion; and
an affective-cognitive system, comprising:
a feature extraction subsystem, adapted for deriving physical information about a user from data obtained from at least one device configured for sensing current physical state data about the user;
a perception subsystem, adapted for processing the physical information received from the feature extraction subsystem in order to determine the user's current posture;
an action selection subsystem, adapted for determining an action to be taken in response to the determined posture and a set of user postural and movement goals; and
a motor system, the motor system comprising at least one device adapted to physically animate the robotic device in accordance with the determined action.

7. The apparatus of claim 6, wherein the action selection subsystem is further adapted for feedback modeling based on a reaction of the user to the movement of the apparatus.

8. A method for improving a user's attention, emotional state, cognitive-affective state, or posture, comprising the steps of:
detecting the user's identity;
monitoring the user's current affective state;
if the user is in a non-neutral affective state, determining whether the user is bored, distracted, blinking, or taking a break;
if not, displaying attention-following behavior;
determining the user's emotional state;
displaying empathetic behavior based on the determined emotional state;
determining the user's feelings about the current behavior; and
increasing or decreasing the probability of choosing the current behavior based on the determined feelings.

9. The method of claim 8, further comprising the steps of:
determining whether or not the user is new or is has not used the system during a prespecified time period; and
if the user is new or is has not used the system during the prespecified time period, exhibiting greeting behavior.

10. The method of claim 9, wherein the greeting behavior exhibited is determined by a user preference setting.

11. The method of claim 9, wherein the steps of determining and monitoring employ data obtained from at least one of a camera sensor, a pressure distribution seat sensor, a task accomplishment detection mechanism and a biometric sensor.
